(19) United States
(12) Patent Application Publication
(10) Pub. No.: US 2014/0337114 A1
(43) Pub. Date: Nov. 13, 2014

(54) Application Activity System

(71) Applicant: Freeband Technologies, Inc., San Jose, CA (US)

(72) Inventor: Thomas Irving Sachson, Menlo Park, CA (US)

(21) Appl. No.: 14/337,529

(22) Filed: Jul. 22, 2014

Related U.S. Application Data
(62) Division of application No. 13/206,044, filed on Aug. 9, 2011.
(60) Provisional application No. 61/372,090, filed on Aug. 9, 2010.
(60) Provisional application No. 61/390,256, filed on Oct. 6, 2010.
(60) Provisional application No. 61/435,295, filed on Jan. 22, 2011.
(60) Provisional application No. 61/472,546, filed on Apr. 6, 2011.
(60) Provisional application No. 61/478,623, filed on Apr. 25, 2011.

(51) Int. Cl. G06Q 30/02

(52) U.S. Cl. CPC G06Q 30/0224
USPC 705/14.25

(57) ABSTRACT

A data connection method for establishing a data connection between a bandwidth user (an application user) of a network connected user access device and a data source on a network connected target device over a communication network relating to the provision of data connection services to the user utilizing a subsidized application to allow the user of the subsidized application access to at least one target devices via a communication network, the method comprising: providing, via the communication network, a content and services brokerage engine, including a content and services brokerage engine web site store front, providing, via the web site, an online sale of a data connectivity package to at least one provider of a subsidized application; and, accepting, via the web site the purchase by a provider of a subsidized application of the at least one data connectivity package for inclusion by the provider of the subsidized application into a subsidized application to be used by a user of the subsidized application to access at least one target device as specified by the provider of the subsidized application on a data connection basis.

### CROSS-REFERENCE

This application claims the benefit of U.S. Provisional Applications Nos. 61/372,090, by Sachson, entitled Application Activity System Variant 1, filed on Aug. 9, 2010, 61/390,256, by Sachson, entitled Application Activity System Variant 2, filed on Oct. 6, 2010, 61/435,295 by Sachson, entitled Application (“App”) Activity System, filed on Jan. 22, 2011, 61/472,546 by Sachson, entitled Application (“App”) Activity System, filed on Apr. 6, 2011, and 61/478,623 by Sachson, entitled System And Method For Bundled Sale Of Digital Content And Electronic Delivery Means, filed on Apr. 25, 2011, the disclosures of which applications are incorporated herein by reference.

### BACKGROUND OF THE INVENTION

By way of background, many households (up to 30 million in the U.S. alone, with many more globally) do not have online bandwidth access, often due to the prohibitive cost of the monthly online bandwidth subscription. To address this, some market participants have tried to launch commercial frameworks where one party acts as a payor, such as a commercial party payor, who subsidizes the online bandwidth connectivity fees for another party (e.g., the payor's customers, potential customers, service recipients, users of governmental agency services, or otherwise) that is consuming bandwidth on a network in the course of accessing various online data sources (e.g., web content) via the Internet. These efforts, however, have failed mostly because there exists no low cost, scalable, and transparent method for consolidating those parties who wish to subsidize online bandwidth access with those parties that seek the subsidy. Of note, existing methods for consolidating the above referenced parties are especially difficult and costly to implement within the boundaries of an access provider's (e.g., broadband access provider) owned and operated communication network. The systems and methods of the present application address this failure and other aspects of providing online bandwidth access to content and services through the use of systems and methods to more effectively bring these parties together to create a market for subsidized bandwidth access.

U.S. Pat. No. 6,181,690 to Civanlar for Toll-Free Internet Service describes a method for providing a toll-free connection between an end user and a site provider; U.S. Publication US 2005/0044243 A1 to Narayanan et al. for System for Toll-Free or Reduced Internet Access describes a toll-free-or reduced toll Internet access system; U.S. Pat. No. 6,425,010 to Alles et al. for Steering of Internet Access to Sponsors described steered Internet access; U.S. Pat. No. 7,848,312 to Zhang et al. for Method and Systems for Toll-Free Internet Protocol Communication Services describes toll free IP business model; U.S. Pub. US 2010/195503 A1 to Raleigh for Quality of Service for Device Assisted Services discloses QoS for DAS; U.S. Pub. US 2010/0197266 A1 to Raleigh for Device Assisted CDR Creation, Aggregation, Mediation and Billing discloses device assisted CDR creation, aggregation, medication and billing for wireless networks.

### SUMMARY

The following application activity system (“system”) patent describes a data connection method and apparatus for establishing a data connection between an application user (also known as the end user or the end user of bandwidth) on a network connected access device (e.g., a mobile phone, desktop computer, laptop computer, modem, TV, tablet, embedded system, game console, set top box, or analogous) and a data source on a network connected target device (typically a server, but potentially any computer device) over a communication network where the application user's bandwidth consumption activities incur a bandwidth usage charge from the network operator providing the bandwidth connection is disclosed, which may comprise providing, via a communication network, a subsidized application (e.g., an application for web browsing, e-mailing, video sharing, or otherwise consuming bandwidth as it operates that is subsidized by a party other than the immediate user of such application) with a subsidized application identification code associated with both the subsidized application and the application provider (e.g., a party, or its agents, that creates the subsidized application and makes the same available for use by the application user); providing, via a communication network, the application user with a subsidized application for installation on an access device (e.g., such device that is utilized by the application user to enage with online data sources), whereby the subsidized application recognizes and records the access device identification code associated with the access device; allowing, via the subsidized application, the application user access to at least one specified online data address to access target content hosted on at least one target device as pre-determined by the application provider; monitoring and recording, via the subsidized application, the online access activity of the application user utilizing the subsidized application as it engages with the at least one specified online data address and target device; the subsidized application providing to an application activity system registry (“registry”), via the communication network, the recorded access device identification code, the subsidized application identification code associated with the subsidized application, and the recorded online access activity by the application user of the subsidized application as the subsidized application engages with the at least one specified online data address and target device.

The application user may be allowed to access the at least one specified online data address and target device at upload and download speeds pre-determined by the application provider. The application user may be allowed to access the at least one specified online data address and target device at times pre-determined by the application provider. The application user may be allowed to access the at least one specified online data address and target device in accordance with data quantities as pre-determined by the application provider. The method and apparatus may comprise charging, via an application activity system settlement engine (“settlement engine”) that receives one or more registry data outputs (e.g., aggregated from subsidized application online usage data, bandwidth payor contract terms, charge calculations, settlement information) from the registry, an account of the application provider an amount that the provider of such subsidized application has agreed to pay the access provider for the online access provided to the application user utilizing such subsidized application and crediting, via the settlement engine, an account of the access provider with the amount. The method and apparatus may comprise functions for monitoring and recording, via the subsidized application, and include locally storing a record of the online access activity by the application user; and periodically providing, via the communication network, the recorded online access activity (the subsidized application's time of use, time spent online, operating system used, device used, content accessed, bandwidth used, etc.) of the application user to the registry (such reported information to be incorporated into an application data output file). Moreover, the system contemplates also forwarding to the registry, via the communication network, other commercial terms and performance information relating to the creation of the subsidized application.

The subsidized application may be created by the application provider utilizing an application development kit delivered to the application provider by one of the access provider and an agent of the access provider. The registry may also authenticate recorded online access activity provided by the subsidized application with any target device activity supplied by an administrator of the target device interacted with by the application user that is utilizing the subsidized application. The application user may be allowed access, via the subsidized application, to at least one specified online data address to access target content hosted on at least one target device pre-determined by the application provider at no charge to the application user to preview the target content and thereafter the application user is allowed access to upload and download target content via the subsidized application at a pre-specified bandwidth charge rate that is for the account of the application user, the access provider, or shared by both as previously agreed by the parties utilizing elements and/or modules of the system (e.g., the content and services brokerage engine as further described below). The subsidized application may be uploaded by the application provider to a subsidized application marketplace where application users can search for and download the subsidized application to their respective access devices.

A data connection method and apparatus is disclosed which may comprise establishing a data connection between a subsidized application resident on a network connected access device and target content hosted on at least one target device pre-determined by the application provider over a communication network relating to the provision of data connection services to the application user utilizing a subsidized application to allow the application user access to such at least one target device via a communication network, and may comprise providing, via the communication network, a content and services brokerage engine, including a content and services brokerage engine web site store front, providing, via the web site, an online sale of a data connectivity package to at least one application provider; accepting by the access provider, via the web site, the purchase by an application provider of the at least one data connectivity package for inclusion by the application provider into a subsidized application to be used by an application user to access at least one target device as pre-specified by the application provider on a data connection basis. The method and apparatus may also comprise delivering, via a communication network, to each application provider purchasing a data connectivity package from an access provider an application development kit for the creation of at least one subsidized application.

The application development kit will include the relevant contractual terms (in the form of an brokerage data output file) associated with the content and services brokerage engine agreement to provide consideration to the access provider from the application provider in exchange for the bandwidth provider delivering subsidized bandwidth to the application user utilizing the subsidized application. In addition, the application development kit will include a subsidized application identification code associated with any “to be created” subsidized applications and the application provider therein (such code to have been assigned by the content and services brokerage engine at the time the particular application development kit is created), and the application development kit will be delivered by the content and services brokerage engine or other networked elements and/or modules to the application provider via a communication network or other electronic or physical delivery means (e.g., such delivery to be made to a specific application provider ADK download environment). The method and apparatus may also comprise forwarding, via the content and services brokerage engine, to a registry, commercial terms and identification codes relating to a commitment by the application provider to pay data connection charges incurred by the application user (such data to be delivered to the registry in the form of one or more brokerage data output files or analogous); and thereafter preparing, via the registry, data connection charges for an settlement engine to settle credits and debits among the access provider and the application provider.

The method and apparatus may also comprise calculating, via the registry, data connection charges to be paid by the application provider resulting from the application user utilizing the subsidized application to engage with a specified target device, and the registry may also forward such data connection charge calculations to a settlement engine for settlement between the application provider and the access provider and other parties entitled to payment based upon the agreement amongst the parties to create and distrubute the subsidized application.

Consideration negotiated through the content and services brokerage engine owed by the application provider to the access provider (or affiliates/other parties) for bandwidth access (or other valuable consideration) provided to the application user may comprise contingent cash consideration represented by the sharing of advertising revenues earned by the application provider for any on-line advertisement impressions rendered through the subsidized application during use by the application user of the access provider's network. The consideration may also comprise contingent cash consideration represented by the sharing of merchant revenues earned by the application provider from the application user purchasing one of a good and a service during use by the application user of the access provider's network where such merchant revenues earned were affected via the subsidized application. The consideration may also comprise in-kind consideration represented by the provision of one of an online content, a good, and a service to the application user by the application provider (or affiliates/other parties providing such content, goods, or services) as an incentive for the application user to utilize the subsidized application on the network of the access provider. The consideration may comprises in-kind consideration represented by the provision of one of an off-line content, a good, and a service provided to the application user by the provider of such subsidized application as an incentive for the application user to utilize the subsidized application on the access provider's network.

The method and apparatus may comprise a tangible machine readable medium storing instructions that, when executed by a computing device, cause the computing device to perform a method, which may comprise creating a data connection between a subsidized application on a network connected access device and at least one specified online data address associated with target content hosted on at least one target device as pre-determined by the application provider over a communication network where the bandwidth consumption activities by the application user would normally incur a bandwidth usage charge from the network operator providing the bandwidth connection, which may comprise providing a subsidized application with a subsidized application identification code associated with both the subsidized application and the application provider; providing the application user with the subsidized application for installation on the access device, whereby the subsidized application recognizes and records the access device identification code associated with the access device; allowing the application user access to at least one specified online data address to access target content hosted on at least one target device pre-determined by the application provider; monitoring and recording, via the subsidized application, the online access activity of the application user utilizing the subsidized application as it engages with the at least one specified online data address and target device; the subsidized application providing to a registry, the recorded access device identification code, the subsidized application identification code associated with the subsidized application, and the recorded online access activity by the application user of the subsidized application as the subsidized application engages with the at least one specified online data address and target device.

The system and method may be implemented on a computing device utilizing instructions from a tangible machine readable medium.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The features, aspects and advantages of the disclosed and claimed subject matter of the present application are set forth with particularity in the appended claims. A better understanding of the aspects, features and advantages of the disclosed and claimed subject matter will be obtained by reference to the following detailed description that sets forth what are meant to be only illustrative embodiments and not limiting disclosures, in which the principles of the invention are utilized, and the accompanying drawings of which:

FIG. 1 illustrates a high level schematic and block diagram representation of a system and method for promoting subsidized application activity by an application user according to aspects of embodiments of the disclosed subject matter;

FIG. 2 illustrates a schematic and block diagram representation of a system and method for promoting subsidized application activity by an application user according to aspects of embodiments of the disclosed subject matter;

FIG. 3 illustrates a schematic and block diagram representation of a system and method for promoting subsidized application activity by an application user according to aspects of embodiments of the disclosed subject matter;

FIG. 4 illustrate a schematic and block diagram representation of a system and method for promoting subsidized application activity by an application user according to aspects of embodiments of the disclosed subject matter;

FIG. 5 illustrate a schematic and block diagram representation of a system and method for promoting subsidized application activity by an application user according to aspects of embodiments of the disclosed subject matter;

FIG. 6 illustrates an arrangement of software and like modules and functions according to aspects of the disclosed subject matter;

FIG. 7 illustrates a schematic and block diagram representation of a process flow for a subsidized application provider providing free and/or discounted bandwidth access along with “pay as you go” access according to aspects of embodiments of the disclosed subject matter; and

FIG. 8 illustrates an example of a system according to aspects of the disclosed subject matter.

### DETAILED DESCRIPTION

Aspects, features and advantages of the disclosed and claimed subject matter can be seen in the description herein of an application activity system for expanding the access of application users to bandwidth communications by which online value chain participants such as (i) access providers (network operators offering one or more of fixed line and mobile connectivity), (ii) application providers (also referred to herein as interested third party payors of bandwidth charges that are normally attributed to application users who consumed such bandwidth), and (iii) application user's of such subsidized applications (consumers of online access, content, and services via a subsidized application) can all utilize in a coordinated fashion a platform for more efficient, effective, and wide-spread distribution of commercial and non-commercial bandwidth enabled online content and services to the application user population.

The present patent application relates to a mechanism through which certain bandwidth consumption activity objectives are met (e.g., bandwidth provision by an access provider to an application user, payment to the access provider for such consumption of bandwidth by the application user by an interested third party payor/application provider, and the use of a subsidized application by the application user, e.g., such use by the application user being at the behest of the interested third party payor/application provider). By way of an example, the application activity system may comprise a method and apparatus for facilitating online value chain participants such as (i) access providers, such as a carrier like AT&T®, as it relates to the provision of fixed line and mobile bandwidth which the system can render “free” or at a reduced charge for use by application users (ii) providers of the subsidized application (“application providers”), such as an online vender like Amazon®, selling online content and services, and (iii) application users of the subsidized application such as consumers of online content and services for which bandwidth access would be required or at least desirable. Further, such participants can all utilize in a coordinated fashion a method and apparatus e.g., implemented as a software platform, for the efficient and effective distribution of commercial and non-commercial bandwidth enabled content and services to the application user population according to aspects of embodiments of the disclosed subject matter.

While preferred embodiments of the disclosed subject matter are shown and described herein, it will be understood by those skilled in the art that such embodiments are provided by way of example only. Numerous variations, changes, and substitutions will now or in the future occur to those skilled in the art without departing from the spirit of the aspects, features, and advantages of the disclosed and claimed subject matter. It should be understood that various alternatives to the embodiments of the disclosed subject matter described herein may be employed in taking advantage of the aspects, features, and advantages of the disclosed subject matter. It is intended that the appended claims define the scope of the disclosed subject matter and that methods and structures within the scope of these claims and their equivalents be covered by such appended claims.

More particularly an application activity system and method, which may be implemented as a software platform, can enable each of these three value chain participants to more efficiently price, negotiate terms for, and exchange their value inputs within the bandwidth access value chain to the other value chain participants. Generally, each value chain participant has at least the following value inputs to broker (exchange for consideration) through the content and services brokerage engine of the present application:
a. access provider value input, i.e., bandwidth access (e.g., DSL, fiber optic, coax, 3G, LTE, WiMax, Wi-Fi, Satellite, etc.) and bandwidth to access online content and service providers (e.g., software applications, subsidized applications, web pages, audio, video, social networks, communication platforms);
b. application provider value input, i.e., cash resources, as well as, non-cash resources such as online content, software applications, subsidized applications, web pages, audio, video, social networks, communication platforms, and other elements that can be downloaded or otherwise be interacted with and used in one form or another by application users over bandwidth networks, including interacting with other application users or providers of the subsidized application or other elements over a bandwidth network, as well as other online goods and services and offline goods and services;
c. application user of the subsidized application value input, i.e., the ability of the application user to pay either one or more of the access provider and interested third party payor/application provider for the provision of bandwidth as well as content, goods, and services related to utilizing the bandwidth by providing consideration in the form of cash or in-kind services (engaging in online behavior such as participating in online content consumption, advertising, surveys, online commerce, or the like).

The application activity system according to aspects of the disclosed subject matter can provide a transparent, efficient, and effective system by which, e.g., each value chain participant can identify an opportunity for a trade in, e.g., the participant's value input, e.g., as brokered through the system's content and services brokerage engine and execute on such opportunity through a negotiated cash, or the like, or in-kind exchange, or the like, as will be explained in further detail below according to aspects of the disclosed subject matter.

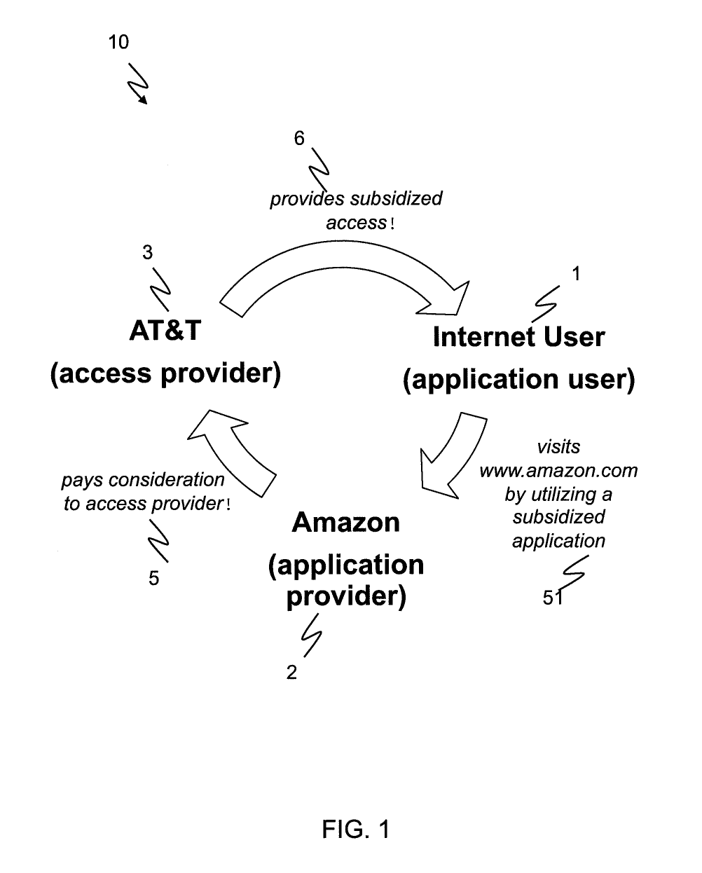

In its most common form, according to aspects of embodiments of the disclosed subject matter, the brokered trading of respective value inputs can involve, for example, three participating parties trading something of value in the form of a “multi-party trade,” such as a “three way trade,” where consideration can be delivered, e.g., by a first party to a second party, and may further include the second party in turn delivering something of value to a third party, who in turn may also deliver something of value to the first party (thus, for example, completing the circle as illustrated In FIG. 1 by way of example, where each party gets something of value in exchange for their contribution within the circle of the value chain). The circle can be more than three, but for purposes of simplicity, examples disclosed herein have been limited to only three party trading groups.

As an example, an Internet user 1 (e.g., an application user 1 utilizing the subsidized application 51 to access online content) may access content found at www.amazon.com that, to some degree or other, may be pre-determined by an application provider 2 (e.g., an interested third party payor) who may or may not be affiliated with the content being accessed (e.g., from www.amazon.com). However, in the example given in FIG. 1, the content being accessed by the subsidized application 51 is in fact created by an affiliate of such content (Amazon® is the application provider 2/interested third party payor). However, another subsidized application as created by Amazon® could be configured to only access content from one or more of the websites found at www.wikipedia.org, www.yahoo.com, etc. Similarly, Yahoo® could just as easily be the application provider 2 of a subsidized application 51 that only accesses Amazon® online services (e.g., those found at www.amazon.com).

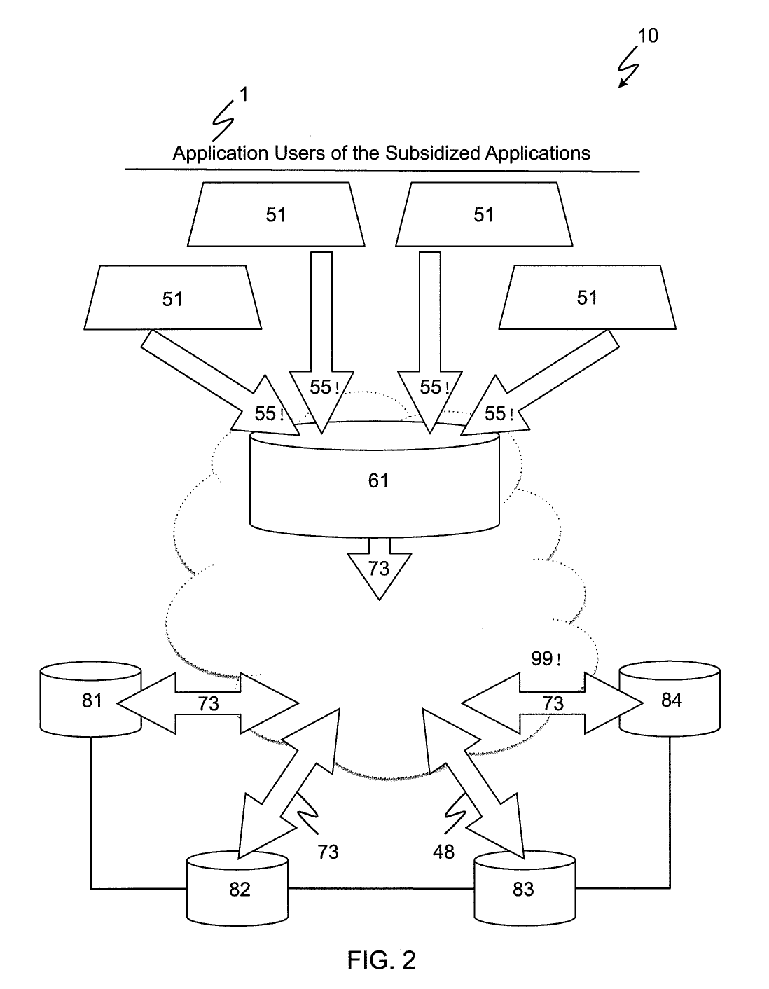

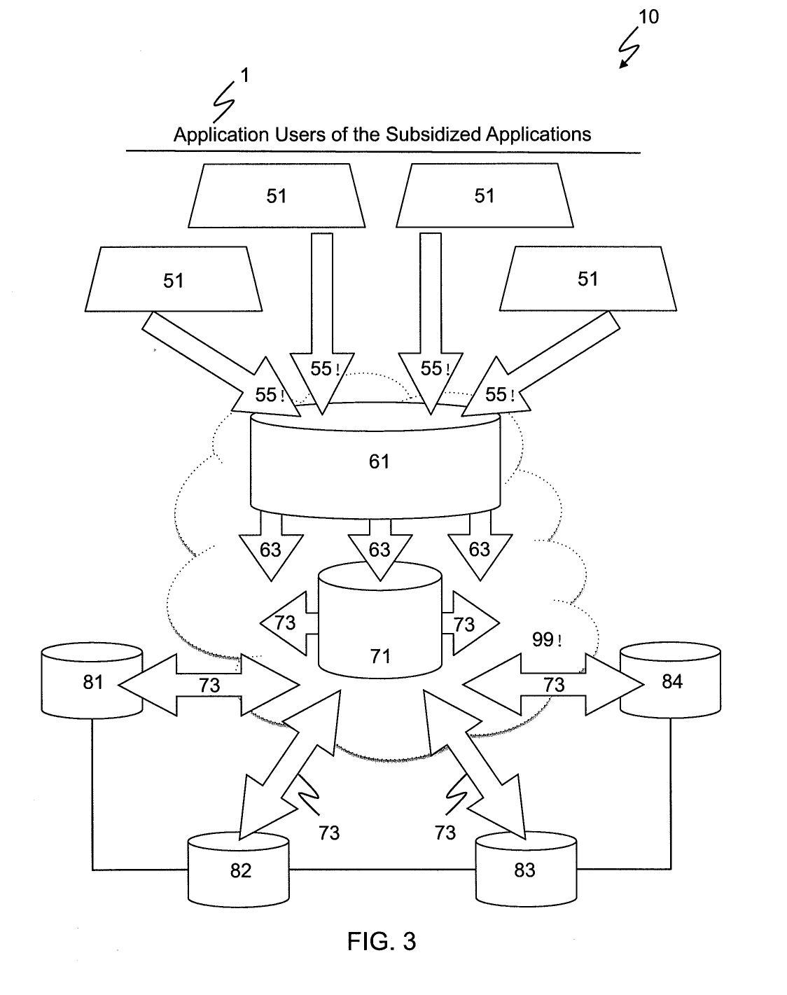

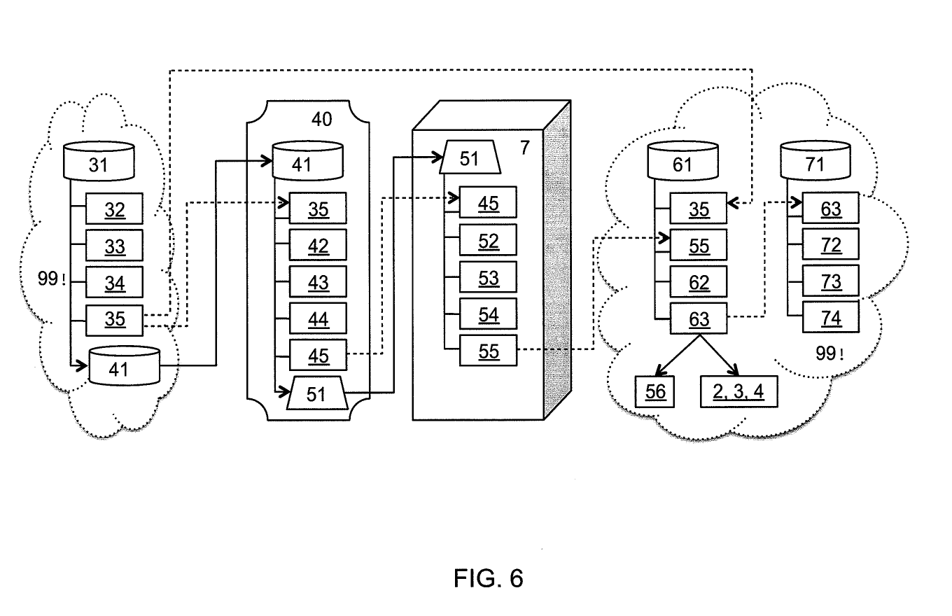

The subsidized access 6 (e.g., application user 1 getting “free” bandwidth access enabled by the access provider 3) may be conducted through an Internet service provider (“ISP”) such as the AT&T® wireline or wireless bandwidth network. As an example, 10 MB of data (subsidized access 6) may be consumed by the application user 1 utilizing a subsidized application 51 as the application user 1 engages, for example, with www.amazon.com. The subsidized application 51 engaging with www.amazon.com may then record and report this online access activity via a online access activity module 54 (e.g., a module within the subsidized application that engages in recordation and reporting functions as discussed below and shown in FIG. 6 herein) and instructs (via a registry 61 and/or settlement engine 71 discussed below and shown in FIG. 2 and FIG. 3 herein) the application provider 2 (in this example case, Amazon®) to pay the access provider 3 (in this FIG. 1 example case AT&T®) for some or all of the cost of the data throughput, such bandwidth indicated by the arrow representing subsidized access 6 in FIG. 1.

There have thus been a plurality of sets of value input exchanges, e.g., three sets of value input exchanges, as is illustrated in more detail in FIG. 1. That is, a value input exchange can occur, i.e., the application user 1 accesses online content of www.amazon.com at the behest of the application provider 2 (in this example case Amazon® itself) for “free” or at a reduce charge in exchange for availing itself to the subsidized application 51 which may be, and in the example is, associated with particular Amazon® content and commercial services. The access provider 3, such as AT&T®, is paid consideration 5 in part or in full for bandwidth provided to application user 1 utilizing the subsidized application 51 by the application provider 2 (Amazon®). The application provider 2 thereby promotes associated content and commercial services associated with the subsidized application 51 at the expense of paying the access provider 3 for some or all of the bandwidth access connection.

Instead of paying the access provider 3 directly for the bandwidth usage charge, the application provider 2 may pay the access provider 3 a percentage (e.g., commission) on sales or advertising revenues garnered by the application provider 2 that was earned in the process of engaging with the application user 1 facilitated through the application user's 1 use of the subsidized application 51. For example, the application provider 2 may pay the access provider 3 a 2% commission, e.g., on the fee charged by the application provider 2 for content provided to the application user 1, e.g., a music file sold to the application user 1 by an application provider 2 such as AOL® or Amazon®, a movie rented to an application user 1 by an application provider 2 such as, Netflix®, participation in an electronic card game, e.g., from an application provider 2 such as the MGM Grand Casino®, and the like. The 2% commission may cover the entire cost of the subsidized access 6 by the application user 1 or represent some discounted or premium charge for such use.

Here again, three sets of value input exchanges thus occur. The application user 1 (the Interent User) of the subsidized application 51 accesses the online content for free (no bandwidth charges accruing to the application user 1) or at a discount, the cost of such free or discounted bandwidth being covered by the commission received by the access provider 3 from the application provider 2 which, therefore, partially or entirely subsidizes the cost of the subsidized access 6 normally paid for by the application user 1 utilizing the subsidized application 51. The access provider 3 is therefore compensated for the cost of providing subsidized access 6 to the application user 1 utilizing the subsidized application 51. The application provider 2 in turn promotes its commercial services or those of its affiliates or partners (e.g., Amazon®, Netflix®, Yahoo!®, MGM Grand®, etc.) to an application user 1 utilizing the subsidized application 51 that otherwise might not afford the unsubsidized access charges (thereby making the application user 1 inaccessible to an application provider 2 or their partners or affiliates) in exchange for sharing revenue with the access provider 3 and/or paying the access provider 3 for some or all of the bandwidth access. Furthermore, the system 10 for generating such a subsidized application 51 affiliate commission could be implemented in an environment where the access provider 3 did not discount the cost of the application user 1 utilizing the subsidized application's 51 bandwidth service, but instead provided a higher quality of bandwidth service (e.g., faster download speeds, more reliable connections, etc.), i.e., in some fashion upgrading the service ordinarily provided, with the cost of the upgrade being paid on behalf of the application user 1 by the application provider 2.

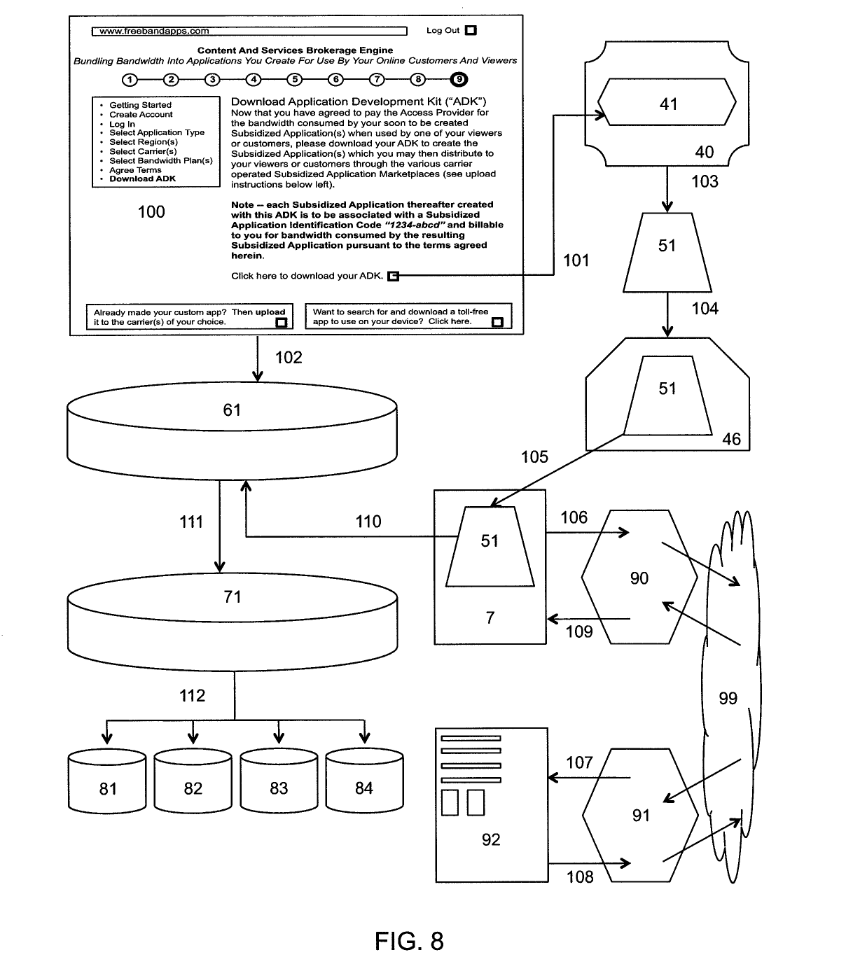

In the alternative, the application provider 2 may configure the subsidized application 51 to not provide any bandwidth support to the application user 1 for initially visiting a first target device 92 (e.g., an Internet site hosted on a target device 92 as discussed below and shown in FIG. 8 herein) associated with the subsidized application 51, but instead will reward the application user 1 with payment for consumption of bandwidth to access at another target device 92 (also accessible through this or another subsidized application 51) after the application user 1 engages in certain activities relating to the first target device 92 visited using the subsidized application 51, e.g., where the application user 1 utilizes the subsidized application 51 to visit www.amazon.com with no bandwidth subsidy support and thereafter purchases $10 worth of music from Amazon®; and as a reward for purchasing such music, the application provider 2 allows that application user's 1 particular subsidized application 51 to watch online music videos on www.youtube.com and consume, for example, 100 MB of bandwidth in the process, for which the application user 1 will not have to pay the access provider 3, or pay a reduced fee as the application provider 2 has arranged for bandwidth charges to be paid to the access provider relating to the application user's 1 bandwidth consumption while downloading YouTube® videos.

In addition, in other situations the application provider 2 can similarly program the subsidized application 51 to provide partially supported bandwidth access to, e.g., www.youtube.com. Moreover, the application provider 2 can similarly program the subsidized application 51 to provide full or partial payment for application user 1 charges not associated with bandwidth per se, but with other goods and services, whether such goods or services are to be attained online or offline, e.g., following the purchase of, for example, the first $10 worth of music from www.amazon.com, rewarding the application user 1 with a free or discounted additional song download, a ticket to a live concert, or associated offline delivery of music clothing and merchandise.

Those skilled in the art will also understand that the application provider 2 need not have a traditional online presence, such as a web site, online business, web domain, etc. The subsidized application 51 can be created by a small business owner with no website or online presence whatsoever (e.g., a local automobile service station), with a desire to make a subsidized application 51 that can be downloaded to an application user 1 who wishes to utilize the subsidized application 51 in a manner that promotes commerce with the business. In doing so, the subsidized application 51 that is provided by the application provider 2 can operate independently of any website and the access provider 3 can be paid for the bandwidth provided based upon a pre-agreed price for amounts of bandwidth consumed or in the alternative through a contigent fee arrangement based upon how the subsidized application 51 is used, e.g., a subsidized application 51 affiliate commission based upon the application user's 1 use of the subsidized application 51 (e.g., by an application user 1 utilizing the subsidized application 51 scheduling a car tune-up using the subsidized application 51 as a facilitating tool).

In this way, the application user 1 (e.g., Internet user utilizing the subsidized application 51) schedules an appointment with the application provider 2 service station using a subsidized application 51 created by the service station, e.g., through an access provider 3 such as AT&T® bandwidth network. The service station subsidized application 51 can record such scheduling activity and instruct the application provider 2 service station to pay access provider 3 a subsidized application 51 affiliate commission, such as $1.00, for enabling the connection between the application user 1 utilizing the subsidized application 51 and the application provider 2, e.g., where 10 MB of data was sent to and from the service station's subsidized application 51 as the application user 1 utilizes the subsidized application 51. In this case, the application user 1 utilizing the subsidized application 51 accesses the application provider 2 service station online content utilizing free or partially paid for subsidized access 6 where the $1.00 commission received by the access provider 3 partially or entirely subsidizes the cost of the subsidized access 6 normally paid for by the application user 1 utilizing the subsidized application 51.

In this case, the access provider 3 is compensated for the cost of providing subsidized access 6 to the application user 1 utilizing the subsidized application 51. The application provider 2 service station promotes its commercial services (automobile repair) to an application user 1 utilizing the subsidized application 51 that otherwise might not afford the unsubsidized access charges (thereby making the potential customer for service inaccessible to the service station application provider 2) in exchange for compensating the access provider 3, e.g., with the $1.00 subsidized application 51 affiliate commission.

As such, it will be clear to those skilled in the art that one major and novel advantage of this system 10 is that these types of bandwidth bartering and cross-subsidy relationships (including relationships dealing with non-bandwidth related content, goods, and services) can be put into effect quickly, widely, and at low cost by the application providers 2 without having to install monitoring, recording, auditing and/or reporting intelligence (e.g., access level gateways, firewalls, deep packet inspection software, permission servers, data request authentications, special log-in protocols, or analogous data monitoring and permissioning elements and/or modules) into the access provider's network per se, and therefore leaves the access provider's 3 core network (physical hardware such as towers, transmitters, servers, gateways, cables, servers, etc. and accompanying software systems) unencumbered and free to support the fast, accurate, and secure flow of data from one part of the network to another. For example, a permission server, e.g., an additional computer element such as a database, registry, server, or analogous device that hosts particular permissioning, monitoring, and recording functions such as access level gateway software, firewall software, deep packet inspection software, data request authentication software, special log-in protocol software, or analogous software utilized in network management, may be required, as has historically been the case, in the access provider's 3 network to monitor, audit, restrict access flows, and bill for “reverse billing” or “toll-free” data activities and the like as reflected in the prior art. The application activity system 10 does not utilize such an “in-network” (in the network of the access provider 3) permission server element and/or module or the like, which has historically been associated with onerous risks, costs, and maintenance complexities for the access provider 3. Instead, this complexity, according to aspects of the presently disclosed subject matter can be captured and managed outside of the network of the access provider 3 by the subsidized application 51 created and distributed by the application provider 2 and other parties (e.g., other affiliated entities).

In contrast to the enclosed system, previous attempts at online interactivity and commerce subsidy bundling required two or more “enabling parties” (e.g., content provider and access provider) to support the activities of an Internet user (e.g., an individual consumer using a piece of software such as a web browser) by having these multiple enabling parties build a customized back-end software system that could interface directly between their own data infrastructures as well as the Internet user's software (usually a web browser). This also posed integration and maintenance costs and security risks to the enabling parties as, over time, they needed to open up their systems to other systems to greater and greater degrees. In the case of the bandwidth access provider (e.g., a mobile or landline carrier), online content providers, and online merchants, these integration, maintenance, and security costs have proven to be prohibitively large and as a result innovative bundling and subsidy relationships (whether tied to bandwidth, content, goods, or services) have not flourished.

However, by leveraging individual subsidized applications 51 (e.g., any one of an Android, webOS, IOS, Windows, MeeGo, Symbian, Linux, Java based subsidized applications 51) that are easily created by the enabling parties (application providers 2), these subsidized applications 51, can easily reside outside of the network of the access provider 3 (at the “edge” of the network) and therein be utilized by the application user 1.

Turning to FIG. 2, one can see that the resulting online access activities (use history, additional billing instructions, etc.) as recorded by the subsidized application 51 (via an online access activity module 54 as discussed below and shown in FIG. 6 herein) can then be paired with other commercial terms and performance information relating to the creation of the application (e.g., the brokerage data output 35 and the application development kit output 45 as discussed below and shown in FIG. 6 herein) and routed in the form of one or more application data output 55 files (a data flow summary that may be comprised of the contract data flowing from the activities of the (i) content and services brokerage engine 31 as described below in FIG. 6, (ii) application development kit 41 as described below in FIG. 6, and (iii) the subsidized application 51 recordation and reporting functions as described below in FIG. 6) to a centralized registry 61, in or accessible through a network or cloud 99, such as the Internet, and such registry 61 not being a device (e.g., server, database, or other analogous element) that is part of the carrier's internal network, as noted above, which registry 61 can record, audit, calculate, and report relevant and summarized activity data (via the creation and delivery of settlement system instructions 73 from internal registry data output 63 files (as discussed below and shown in FIG. 3 herein) created by the registry in the process of collecting and processing data associated with the system 10 activities) directly to the settlement systems of the various participants within the system 10 (e.g., the access provider settlement systems 81, application provider settlement systems 82, other vendor/affiliate settlement systems 83, and application user settlement systems 84).

In the alternative, the registry 61 can deliver registry data output 63 directly to the settlement engine 71 (as shown in the embodiment set forth in FIG. 3) for further processing and the settlement engine 71 can produce and deliver its own set of settlement system instructions 73 (e.g., particular settlement instructions created by the settlement engine 71 which are then at periodic intervals passed on to the settlement systems of the system 10 participants being one or more of the access provider settlement systems 81, application provider settlement systems 82, other vendor/affiliate settlement systems 83, and application user settlement systems 84). In either case, the information sent to the various participant settlement systems (either by the registry 61 or by the settlement engine 71) may cover data relating to participant activities, entitlements, and obligations resulting from the cross-party exchanges (relating to offline and online consideration) enabled by the system 10. As a result, a flexible and easily updatable “outside of the carrier network” clearinghouse is enabled by the system 10 and can enable greater numbers of participating parties (e.g., small businesses, local authorities, and other application providers 2, etc.) to collaborate on, create and distribute customized, low-cost, subsidized applications 51 that provide compelling online and offline content, goods, and services to application user's 1.

Furthermore, having this intelligence (metering, billing, auditing, etc.) being built into a low-cost and flexible subsidized application 51 outside of the network of the access provider 3 (remotely at the edge of the carrier network, e.g., in the home of the application user 1 on an access device 7 such as a mobile phone, laptop, computer, TV, game console, set-top box, tablet, embedded system, modem) enables the access provider 3 to negotiate and implement countless tiered billing and cross subsidy platforms via the intelligence within the subsidized applications 51 themselves instead of having to build this intelligence directly into physical elements managed by the access provider 3 within their carrier network requiring extra equipment, such as permission servers (e.g., servers, databases, and analogous devices hosting functional elements and/or modules in the form of access level gateway software, firewall software, deep packet inspection software, data request authentication software, special log-in protocol software, or analogous data monitoring and permissioning software) that are costly, insecure, difficult to maintain, and may put the core efficacy of the carrier network's performance (e.g., speed, data integrity, security, cost) at considerable risk. Instead, remotely based third party applications, like the subsidized application 51, can easily and reliably generate an online access activity data relating to the activity of an application user 1 of the subsidized application 51, e.g., time of use, operating system used, device used, content accessed, bandwidth used, etc. The data flow can thereafter be fed into requisite system 10 participant processing elements and/or modules, e.g., via wireless, wired, or combinations of both communication path types, e.g., xDSL, WiMax, etc. for review and analysis by these various participants engaging with the system 10. In addition, these subsidized applications 51 can generate online access activity data records that can be received by and processed, e.g., recorded, calculated, audited, distributed, etc., as further Instructions, etc. by the registry 61 and settlement engine 71 to effect the desired settlement according to the participating party agreements at moderate cost to such parties.

FIG. 2 and FIG. 3 also show that the application activity system 10 contemplates numerous functional elements and/or modules as required in the course of providing bandwidth to the markets and is designed to do so in a manner that empowers the subsidized application 51 market participants, i.e., application users 1, application providers 2, access providers 3, affiliates/other parties 4 (as discussed below and shown in FIG. 6 herein), to fully utilize and benefit from the system 10, e.g., to effect settlements for such as cash and/or in-kind exchanges amongst the market participants, e.g., based on settlement instructions delivered in the form of one or more settlement system instructions 73 provided by the registry 61 and/or settlement engine 71, at times operating in conjunction with each other. Registry 61 data (e.g., registry data output 63) can also be analyzed, repackaged as separate data files, and sold to these and other parties.

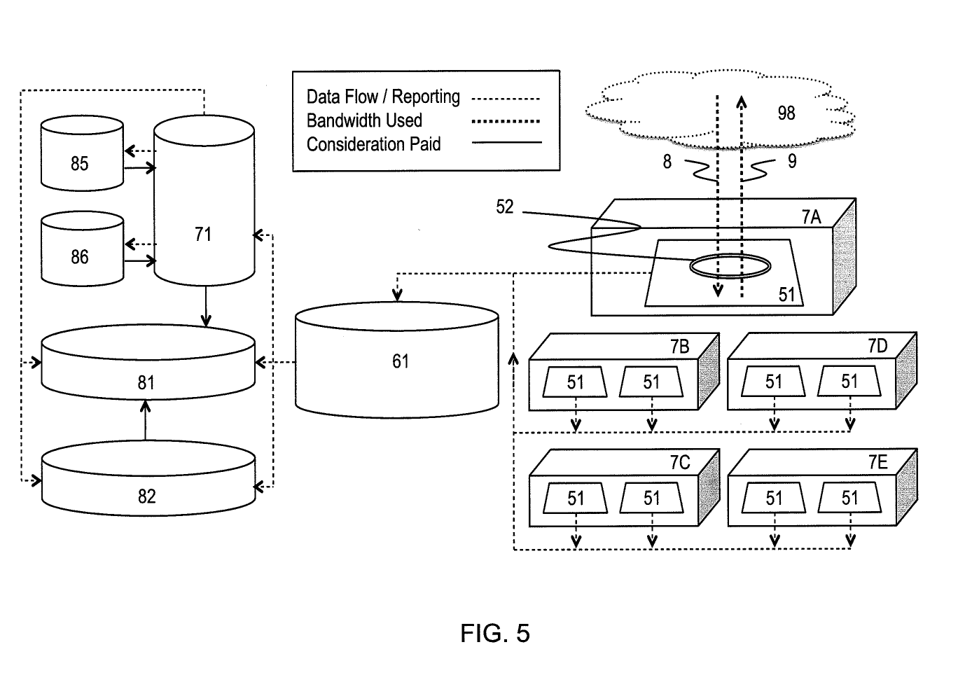

In addition, in FIG. 2 and FIG. 3 there is illustrated schematically and in block diagram form aspects of embodiments of the disclosed subject matter. The system 10 as illustrated in FIG. 2 may include only a registry 61, whereas in FIG. 3 the system contemplates both a registry 61 and a separate settlement engine 71, that independently or in unison may perform a number of core functions, which may include linking and/or coordinating the functions of various data sources distinct from the system 10, e.g., to provide an application user 1 utilizing the subsidized application 51 with a means to settle financial or economic obligations resulting from the use of the subsidized application 51 including, e.g., using bank account 85 data and/or credit card account 86 data (as further shown in FIG. 5 below) of the application user 1 utilizing the subsidized application 51 to effect settlement activities with the relevant application user's 1 bank account 85 and credit card account 86 providers (such entities representing the application user settlement systems 84). Also (as discussed below and shown in FIG. 6 herein) the registry 61 may communicate registry data output 63 data to access providers 3, application providers 2, and affiliates/other parties 4 for purposes of authenticating online access activity recorded and reported by the subsidized application 51 to other elements within the system 10. Also (as discussed below and shown in FIG. 6 herein) the registry 61 may communicate registry data output 63 data to one or more use metering applications 56 that can report to the application user 1 their bandwidth consumption use statistics as well as their credit/debit status vis-à-vis the other system 10 participants (e.g., cash owed and/or earned bandwidth, content, goods, services), as well as their limits reached and/or almost reached for bandwidth consumption on certain subsidized applications 51, and in the process assist the application user 1 in managing and optimizing their online behaviors.

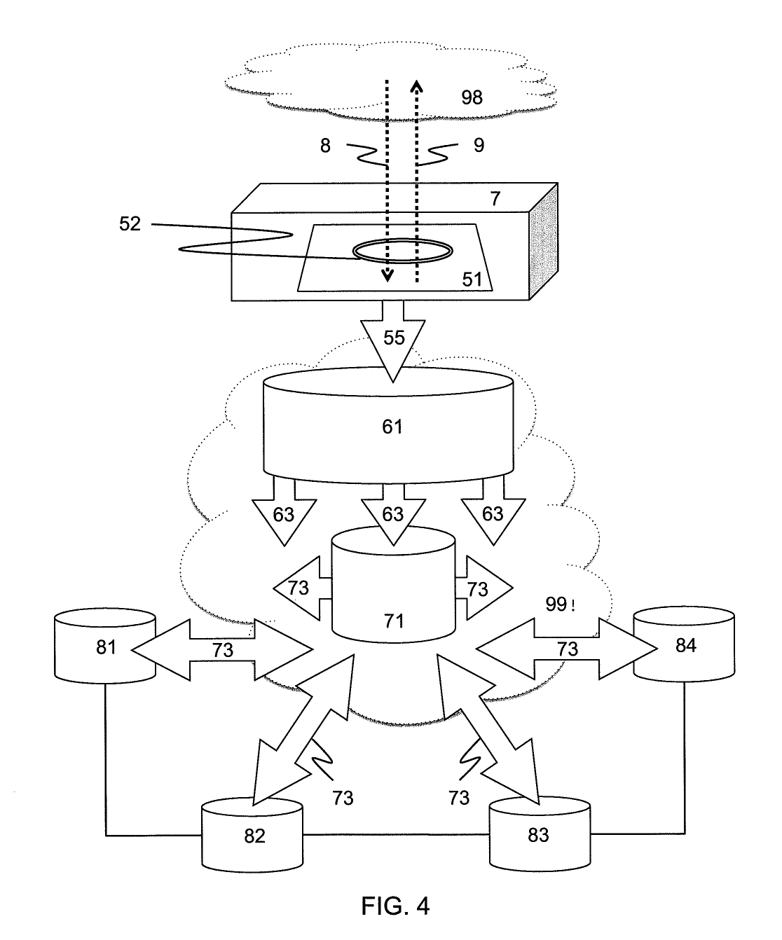

Turning to FIG. 4, as an example of the operation of the subsidized application 51 as it engages with target content accessed through the Internet, the subsidized application 51 will reside on an access device 7 (such as a mobile phone, game console, TV, set top box, tablet, desktop computer, laptop computer, other embedded system, modem, or analogous) and may monitor its bandwidth consumption in terms of data coming into the subsidized application 51 (inbound data usage 8) from the world wide web 98 or Internet and/or also in terms of data going out from the subsidized application 51 (outbound data usage 9) out to the world wide web 98 or Internet. Moreover, as can be seen in the FIG. 4 example, such management of inbound and outbound data flows is handled by an inside-the-application firewall 52 (or an analogous access permissioning and management element and/or module as distinct from a firewall or analogous permissioning element and/or module that may be part of the physical network infrastructure of the access provider 3 and/or embedded into the operating system of a device modem that communicates with the physical network infrastructure of the access provider 3) that serves as a permissioning element and/or module inside of the subsidized application 51 itself, alleviating the access provider 3 and/or the administrator of the target device from monitoring, recording, analyzing, auditing, and reporting on these online access activities of the subsidized application 51 from within the carrier network and/or the target device 92 respectively. However, nothing in this patent should suggest that the inside-the-application firewall 52 would not be capable of operating in conjunction with the firewall or analogous permissioning elements and/or elements that are part of the physical network infrastructure of the access provider 3 and/or the administrator of a target device.

As an example of the core functions that the application activity system 10 may perform, the registry 61 may link, perform operations upon, corroborate, and otherwise interact with various key data sources, e.g., application provider 2 contract data (in the form of one or more brokerage data output 35 files as discussed below and shown in FIG. 6 herein) provided by the content and services brokerage engine 31, application development kit output 45 data (as discussed below and shown in FIG. 6 herein), online access activity data (as discussed below and shown in FIG. 6 herein) from the subsidized application 51 (in the form of one or more application data output 55 files), the settlement engine 71 which in turn links to the access provider settlement systems 81, application provider settlement systems 82, other vendor/affiliate settlement systems 83, and application user settlement systems 84 (including the application user's 1 bank accounts 85 and credit card accounts 86).

As such, the registry 61 is capable of recording and reporting upon various online access activity data records of the subsidized application 51, such as time of use, bandwidth used, e.g., both to send and receive, content accessed, as well as the access device identification code (e.g., operating or hardware identification elements such as a MAC address or analogous) gathered from the access device 7 hosting the subsidized application 51. These core functions may also include, linking other affiliated data sources (such as application user 1 bank account 85 information and credit card account 86 information as shown in FIG. 5 herein), as well as recording, processing, and sharing data relating to the use of each subsidized application 51 with other parties entitled to such data, including but not limited to the application's time of use, bandwidth used (e.g., sent and received), and content accessed. In addition, these functions may facilitate the calculation of cash and in-kind credits and debits (such as credits and debits for earned applications, credits and debits for earned content (e.g., audio and/or video), and credits or debits for earned bandwidth (e.g., restricted use and/or unrestricted use), as well as facilitate aggregations, e.g., allowing netting of uniform credit and/or debit elements amongst different participants within the system 10 (e.g., application users 1, application providers 2, access providers 3, and/or affiliates/other parties 4), as well as enabling transfers in the form of non-cash bartering, e.g., allow trading of uniform elements like cash balances and/or bandwidth credits/debits amongst different participants within the system 10 (e.g., application users 1, application providers 2, access providers 3, and/or affiliates/other parties 4), and facilitating instructions on settlement (e.g., credits and debits for earned applications, credits and debits for earned content (audio and/or video) and credits and debits for earned bandwidth (restricted use and/or unrestricted use)).

As further illustrated by way of example in FIG. 4, each type of access device 7 has one or more subsidized applications 51 associated with it. Each such subsidized application 51 is configured to communicate its embedded application development kit output 45 data (as discussed below and shown in FIG. 6 herein) and its online access activity data to the registry 61 (such communications to be in the form of one or more delivered application data output 55 files). Additionally, inbound data usage 8 and outbound data usage 9 can be further controlled (throttled for data send and receive speed, enforcing periodic data limits, enforcing time of use permissions, enforcing device type permissions, and other analogous access control functions) by the inside-the-application firewall 52 as the subsidized applications 51 communicates with various target devices 92 accessed on the world wide web 98 or Internet.

Also the registry 61 can calculate cash and in-kind consideration, credits and debits that have been “earned” or “depleted” by the application user 1 as they utilize the various subsidized applications 51, e.g., for earned applications, for earned subsidized applications 51, for earned content, such as, audio and/or video, and for earned bandwidth, including, e.g., earned bandwidth that is restricted, i.e., so called because it is to be consumed only in the course of engaging with Internet resources as pre-determined by the application provider 2 and/or unrestricted and capable of being consumed in the course of engaging with any Internet source of the application user's 1 choosing. Further, the subsidized applications 51 may operate on devices and operating systems whose communication path is to or through the network on a wireless or wired basis, or a combination of both, including, by way of example, based on a mobile communication standard, such as, LTE, a wireless standard for connecting electronic devices, such as, Wi-Fi, or Worldwide Interoperability for Microwave Access (“WiMAX”), telecommunications standards, such as, satellite, digital subscriber line technologies, such as, xDSL, coaxial cable, fiber optic, and the like.

Turning again to FIG. 4, the registry 61 may also effect aggregations, such as, by allowing netting of uniform elements (cash, bandwidth credits, etc.) amongst different system 10 participants, including, e.g., application users 1 of the subsidized applications 51, content providers (who may or may not also be application providers 2), access providers 3, and/or affiliates/other parties 4 of the system 10 such as banks, credit card providers, other vendors, etc. The registry 61 may also effect non-cash barter, such as, by allowing trading of so-called uniform elements (e.g., cash, bandwidth credit/debts) amongst different system 10 participants and, including, e.g., application users 1 of the subsidized applications 51, content providers (who may or may not also be application providers 2), access providers 3, and/or affiliates/other parties 4 of the system 10 such as banks, credit card providers, other vendors, etc. The registry 61 may also provide instructions relating to settlements that may administered by any one or more of itself, the settlement engine 71, or a third party settlement system, e.g., providing credits/debits for earned software, credits/debits for earned subsidized applications 51, credits/debits for earned content, such as audio and/or video, and credits/debits for earned bandwidth (restricted and/or unrestricted). Furthermore, the online access activity data relating to these credits/debits may include data relating to the application user 1 accessing core content, viewing third party advertisements, and purchasing items.

Turning to FIG. 5, there is illustrated another embodiment of the invention incorporating elements from the previous embodiments, but configuring the elements in such a manner so as to demonstrate the flexibility, novelty, and value of the system. Of note, because the subsidized applications 51 can reside on the access device 7 in any quantity (access device 7 internal memory notwithstanding) on any number of access devices 7 and device types (e.g., on the operating system of a modem type device 7A, on the operating system of a set top box type device 7B, on the operating system of a personal computer type device 7C, on the operating system of a mobile phone type device 7D, on the operating system of any other embedded system type device such as a TV, car, household appliance, tablet, game console, or analogous), the system 10 is capable of promoting and handling an enormous amount of complexity in terms of participants, carrier network technologies, application types, device types, geographies, cross-subsidy arrangements, and subsidized application 51 performance parameters, and simplify the monitoring of such activities, as well as the recording, auditing, reporting upon, and consideration settlements related to such activities, in a manner that is scalable and low cost from the perspectives of the system 10 participants.

These efficiencies are further apparent in the FIG. 5 illustration as it shows the system effectively “splitting” the data flow process associated with the reverse (subsidized) billing of data. In the example given, the data (bandwidth) consumed (“used”) by the application user 1 for engaging with online content and resources is represented by the heavy set dotted arrows 8 and 9. However, the data pertaining to the manner in which this bandwidth is consumed by the application user 1 is represented by the lighter arrows flowing away from the subsidized applications 51 on the left hand side of the figure and making their way to the various tracking, recording, processing, reporting, and settlement elements of the system 10 on the left hand side of the figure (e.g., registry 61, settlement engine 71, etc.). This “splitting” out of data stream types at the subsidized application 1 level (on the access device 7) is one of the key differentiators and improvements of the current invention over the prior art, in that in the prior art the carrier wishing to reverse bill for an inbound data usage 8 or an outbound data usage 9 would have to configure their network infrastructures to identify which packets were being subsidized by third party payors and which packets were not. This is currently done by tying packet identifiers (deep packet header info, etc.) to particular payors and tallying the results in the network as the packets (bytes) pass through. The existing networks were not built to do this in any meaningful way (e.g., simultaneously for thousands, and perhaps millions, of data stream payors) and this has been one of the reasons why “toll-free” data has not flourished to date. In the current invention, the subsidized application 51 (as the first and last end point for inbound data usage 8 and outbound data usage 9 activity) is uniquely positioned to record these byte traffic activities and immediately pair them with data pertaining to the consumer of such bytes (the application user 1) and the third party payor of the bytes (the application provider 2). As such, three key data elements needed to effect a toll-free data activity are all co-located in one secure, specialized data collection point (the subsidized application 51), distributed on a large swarm (e.g., billions) of hosting devices (the access devices 7). This allows for the wide-spread roll-out and management of toll-free data services to the carrier's customers, while also offering almost unlimited complexity in terms of bandwidth and data access bundling/cross-subsidy activities offered, and is scalable at a low cost to the access provider 3 since they do not have to build much (if any) new intelligence into their existing networks to effect such a profound utility in the functionality of their networks.

In light of the various embodiments shown in FIG. 2, FIG. 3, FIG. 4, and FIG. 5, those versed in the art can appreciate that there will be a variety of forms that the system elements can take, as well as the order in which they process certain information, without deviating from the underlying scope of the current invention that provides a customizable, scalable, low cost mechanism to track, record, and bill for bandwidth consumption (and related non-bandwidth consumption activities) where a party other than the party that normally would incur the cost associated with consuming such resource is subsidized in whole or in part by an interested third party payor, and where such subsidy mechanism can take place in a computer (hardware and software) system that is apart from and distinct from the existing infrastructures of a bandwidth access provider, relieving such access provider of the burden of configuring, monitoring, and maintaining their existing communications systems in the course of providing this type of reverse billing (subsidized/toll-free) data functionality to their end user customers.

Turning now to FIG. 6 there is illustrated tools and an operating platform that may be utilized to create an application activity system 10 as described above. Given the need to simultaneously satisfy various parties in each value input trading scenario, the software platform can require a level of sophistication that is currently unavailable in the prior art. Specifically, the application activity system 10 can be enabled by a software system that may be comprised of five elements and/or modules that can interact with one another and coordinate the resulting interactions between the providers of the respective value inputs. Three of these elements and/or modules have been discussed above, i.e., the registry 61, the settlement engine 71, and the subsidized application 51.

The remaining elements and/or modules as set forth below are software systems that assist in the creation of the subsidized application 51, the creation of the agreement between the various parties to the system 10 (e.g., the access providers 3, application providers 2, and/or affiliates/other parties 4), and the maintenance of the registry 61 and the settlement engine 71. More specifically, these are a content and services brokerage engine 31 (also referred to as a “Value Input Trading System” or “VITS”), and an application development kit 41 (“ADK”). The content and services brokerage engine 31 can be a web-based software platform that can be made available to the application providers 2 so that the application providers 2 can coordinate commercial terms (e.g., a mechanism to trade participants' value inputs, whether related to bandwidth, content, cash, time, or otherwise) in advance of making a subsidized application 51 available for distribution to the application user 1 seeking to utilize the subsidized application 51. Moreover, the content and services brokerage engine 31 can also allow prospective enabling parties (application providers 2, access providers 3, affiliates/other parties 4, etc.) to negotiate and bid on the value of their value inputs, e.g., allowing the content and services brokerage engine 31 to act as not just a bandwidth trading platform, but a full content and services brokerage engine that can match application providers 2 with other diverse market participants who might wish to collaborate, e.g., on the creation of a system-wide subsidized application 51.

Of note, the content and services brokerage engine 31 will prompt the user of such to select from a menu of commercial terms 32 based upon the value inputs provided to the content and services brokerage engine 31 by participating parties (e.g., the access provider 3) so that an agreement may be formed by the various parties utilizing the content and services brokerage engine 31, e.g., price, delivery quantities, speeds, time periods, eligible parties, etc. Thereafter, the content and services brokerage engine 31 will prompt the user of the content and services brokerage engine 31 to select from a choice of application type input templates 33 (e.g., template form to create a subsidized application 51 that allows access to an Internet resource such as a web page format (for accessing news/portal/reference), an e-commerce content site, a social media site, a photo/video/music site(s) an e-mail site, or a communications (voice/video) site as examples) that is being contemplated by the interested third party payor 2 (the application type that is to be created for utilization by an application user 1). Thereafter, the content and services brokerage engine 31 will prompt the user of the content and services brokerage engine 31 to specify the settlement methods 34 to be incorporated into the agreement to provide an application user 1 with a subsidized application 51. Once these items (and any other required elements) are agreed and submitted to the content and services brokerage engine 31, the content and services brokerage engine 31 will generate a unique contract code relating to the agreement (the subsidized application identification code).

Together, the commercial terms 32, application type input templates 33, settlement methods 34, and subsidized application identification code will comprise the brokerage data output 35 which may then be forwarded to the registry 61 and further incorporated within the unique application development kit 41 to be delivered to the interested third party payor 2.

With regard to the creation of the unique application development kit 41, the unique brokerage data output 35 will be incorporate into the application development kit 41 so that any subsidized applications 51 created by such application development kit 41 by the interested third party payor 2 (or their agents) will also have embedded within it the unique brokerage data output 35 data (in the form of the application development kit output 45 embedded within the subsidized application 51 itself). As such, the subsidized application 51 can use this embedded information to better manage its bandwidth consumption and adhere to the performance terms agreed to by the parties who utilized the content and services brokerage engine 31 to come to a contractual agreement relating to the creation and use of the subsidized application 51 (enabling self monitoring, permissioning, recordation, and reporting of online access activity data by the subsidized application 51 to the registry 61 in the form of one or more application data output 55 files for further analysis and action by the system 10.

With regard to the brokerage data output 35 that is sent by the content and services brokerage engine 31 to the registry 61 following the agreement by the parties, such brokerage data output 35 will be used by the registry 61 to corroborate information coming from the subsidized application 51 in the form of one or more application data output 55 files. If the data from the application data output 55 and the brokerage data output 35 conflict, then this will prompt the administrator of the registry 61 to investigate the apparent conflict and ascertain whether corrective action is required by one or more of the participants or to elements and/or modules within the system 10 (e.g., perhaps instructing the content and services brokerage engine 31 to prepare a newly amended application development kit 41 for delivery to the application provider 4, notifying the application provider 4 that the subsidized application 51 software has been compromised or is failing to perform as required and needs to be removed and/or updated, etc.).

Turning again to the application development kit 41 in FIG. 6, the content and services brokerage engine 31 will deliver such development kit to an operating environment (the application provider ADK download environment 40) of the interested third party payor's 2 choosing (e.g., perhaps a computer or laptop with an operating system capable of running the application development kit 41). From there, the user of the application development kit 41 will open the development kit and create the one or more desired subsidized applications 51 by choosing from the various developer interface templates 42 enclosed therein and modifying them accordingly using the functional elements and/or modules of the application development kit 41. In the process of creating the subsidized applications 51 the user of the application development kit 41 may also add or modify application core functions 53 (e.g., application performance parameters relating to data caps, access speeds, time of use, online target device 92 destinations, permitted device types, etc.), utilizing the application core functions tools 43 in the application development kit 41, so long as such does not conflict with the terms and performance parameters agreed by the parties via the content and services brokerage engine 31 prior to the same creating the application development kit 41 (“conflict” meaning that the system 10 would be impeded in its basic functions of providing the application user 1 with bandwidth access, participant cross-subsidy of consideration, and the requisite settlements thereof as agreed by the parties utilizing the content and services brokerage engine 31).

Once the user of the application development kit 41 has completed the design and creation of the subsidized application 51 (including the design of application core functions 53, including but not limited to user interface features, data sources accessed, interactivity elements, etc.), all of the key data inputs (e.g., the brokerage data output 35, the developer interface template 42 selections and edits, the application core functions tools 43 selections and edits (e.g., application performance parameters relating to data caps, access speeds, time of use, online target device 92 destinations, permitted device types, etc.), and the application recordation and reporting function tools 44 selections and edits) are collectively encapsulated within an application development kit output 45 file that is incorporated into the subsidized application 51. This application development kit output 45 so embedded can then be used to manage the use of such subsidized application 51 (part of such management to be effected by the use of the inside-the-application firewall 52 that is a functional element and/or module within the subsidized application 51) as it is utilized by an application user 1, and to facilitate the co-monitoring and recordation of the resulting online access activity and reported (such online access activity by the subsidized application 51 to be recorded and reported through an online access activity module 54 therein) as it is utilized, and to aggregate this recorded data with the recorded performance parameters from the application development kit output 45 into application data output 55 that can then be reported to the registry 61.

Once the application data output 55 is received and processed by the registry 61, the registry 61 can then process this information in conjunction with information previously received from the content and services brokerage engine 31 (in the form of the brokerage data output 35) relating to the overall terms that were agreed between the various parties (e.g., the application provider 2, the access provider 3, and affiliates/other parties 4), with such resulting processed data (including the processing and creation of settlement calculations, settlement methods, etc.) to collectively form registry master records 62 (e.g., records of all relevant free and/or discounted access hours, bandwidth quantities, applications, content, services, goods or analogous provided to the application user 1 by the system 10), that can be forwarded to one or more of the settlement engine 71, the application provider 2, the access provider 3, affiliates/other parties 4, any use metering application 56, or other party, as needed, in the form of one or more registry data output 63 files. If received by the settlement engine 71, the one or more registry data output 63 files can serve as the basis for the settlement engine 71 to formulate and effect the manner in which all relevant participating parties should settle obligations and/or expectations with one another, e.g., cash, in-kind, etc (such new processed data being the settlement engine master records 72). As such, the settlement engine 71 is enabled to record, process, and invoice appropriate parties for the services provided by the application activity system 10. The settlement engine 71 can thereafter provide settlement instructions to the various parties requiring such in the form of one or more settlement system instructions 73. Should the settlement engine master records 72 need to be shared, processed, or otherwise acted upon by another element of the system 10 or element not part of the system 10, then such data can be delivered in the form of settlement engine data output 74.

As such, it will be understood by those skilled in the art that the system 10 can take various forms and achieve various objectives of the participants. In a first mode, a first subsidized application 51 may be created by an application provider 2 that may provide free and/or discounted bandwidth access for the application user 1 to send and receive data relating to one or more pre-specified first target devices 92 (e.g., restricted destinations) and according to performance parameters (data transport speeds, data quantity caps, time periods for data transfers, contingent rewards for certain application user 1 actions, etc.) as pre-determined by the application provider 2. In this case, the payment to the access provider 3 for this restricted access is borne by the application provider 2 (and its agents and affiliates) and can be managed by the registry 61 and settlement engine 71 working in unison as described above. Furthermore, performance parameters will be enforced and managed by the inside-the-application firewall 52 (or analogous module(s)) that is internalized within this first subsidized application 51.

In a second mode, a first subsidized application 51 in the first mode cited above may be created by an application provider 2 that when used in a particular way (e.g., when accessing core content, viewing third party advertisements, purchasing goods or services, participating in gaming and/or gambling, participating in social networking, and/or providing personal information) by the application user 1 will result in the application provider 2 delivering a separate, second subsidized application 51 to the application user 1 to facilitate free and/or discounted bandwidth access for the application user 1 to send and receive data relating to one or more pre-specified second target devices 92 (e.g., restricted destinations) and according to performance parameters (data transport speeds, data quantity caps, time periods for data transfers, contingent rewards for certain application user 1 actions, etc.) as pre-determined by the application provider 2. In this case, the payment to the access provider 3 for this additional restricted access is borne by the application provider 2 (and its agents and affiliates) and can be managed by the registry 61 and settlement engine 71 working in unison as described above. Furthermore, performance parameters relating to the second application will be enforced and managed by the inside-the-application firewall 52 (or analogous module(s)) that is internalized within the second subsidized application 51.

In a third mode, a first subsidized application 51 in the first mode cited above may be created by an application provider 2 that when used in a particular way (e.g., when accessing core content, viewing third party advertisements, purchasing goods or services, participating in gaming and/or gambling, participating in social networking, and/or providing personal information) by the application user 1 will result in the application provider 2 delivering a separate second subsidized application 51 to the application user 1 to facilitate free and/or discounted bandwidth access for the application user 1 to send and receive data relating to any target devices 92 (e.g., unrestricted destinations) of the application user's 1 choosing and according to performance parameters (data transport speeds, data quantity caps, time periods for data transfers, contingent rewards for certain application user 1 actions, etc.) as pre-determined by the application provider 2. In this case, the payment to the access provider 3 for this additional unrestricted access is borne by the application provider 2 (and its agents and affiliates) and can be managed by the registry 61 and settlement engine 71 working in unison as described above. Furthermore, performance parameters relating to the second application will be enforced and managed by the inside-the-application firewall 52 (or analogous module(s)) that is internalized within the second subsidized application 51.

In a fourth mode, a first subsidized application 51 in the first mode cited above may be created by an application provider 2 that when used in a particular way (e.g., when accessing core content, viewing third party advertisements, purchasing goods or services, participating in gaming and/or gambling, participating in social networking, and/or providing personal information) by the application user 1 will result in the application provider 2 delivering online to the application user 1 a free or discounted application, content element, or service. In this case, the payment to the provider of such online application, content element, or service is borne by the application provider 2 (and its agents and affiliates) and can be managed by the registry 61 and settlement engine 71 working in unison as described above.

In a fifth mode, a first subsidized application 51 in the first mode cited above may be created by an application provider 2 that when used in a particular way (e.g., when accessing core content, viewing third party advertisements, purchasing goods or services, participating in gaming and/or gambling, participating in social networking, and/or providing personal information) by the application user 1 will result in the application provider 2 delivering offline to the application user 1 a free or discounted application, content element, good, or service. In this case, the payment to the provider of such offline application, content element, good, or service is borne by the application provider 2 (and its agents and affiliates) and can be managed by the registry 61 and settlement engine 71 working in unison as described above.

In a sixth mode, a subsidized application 51 in the first mode cited above may be created by an application provider 2, save that it may instead provide free and/or discounted bandwidth access for the application user 1 to send and receive data relating to one or more pre-specified target devices 92 (e.g., restricted destinations) or application user 1 chosen target devices 92 (e.g., unrestricted destinations) and do so for a set period of time or until a set amount of bandwidth is consumed by the application as pre-determined by the application provider 2 (such limited initial access/viewing period to be referred to a “preview period”). At the close of such preview period the subsidized application 51 thereafter adheres to performance parameters (data transport speeds, data quantity caps, time periods for data transfers, pre-selected target devices 92, etc.) as pre-determined by the application provider 2. In this case, the payment to the access provider 3 for this “preview” access is borne by the application provider 2 (and its agents and affiliates) and can be managed by the registry 61 and settlement engine 71 working in unison as described above. Furthermore, performance parameters will be enforced and managed by the inside-the-application firewall 52 (or analogous module(s)) that is internalized with this first subsidized application 51.

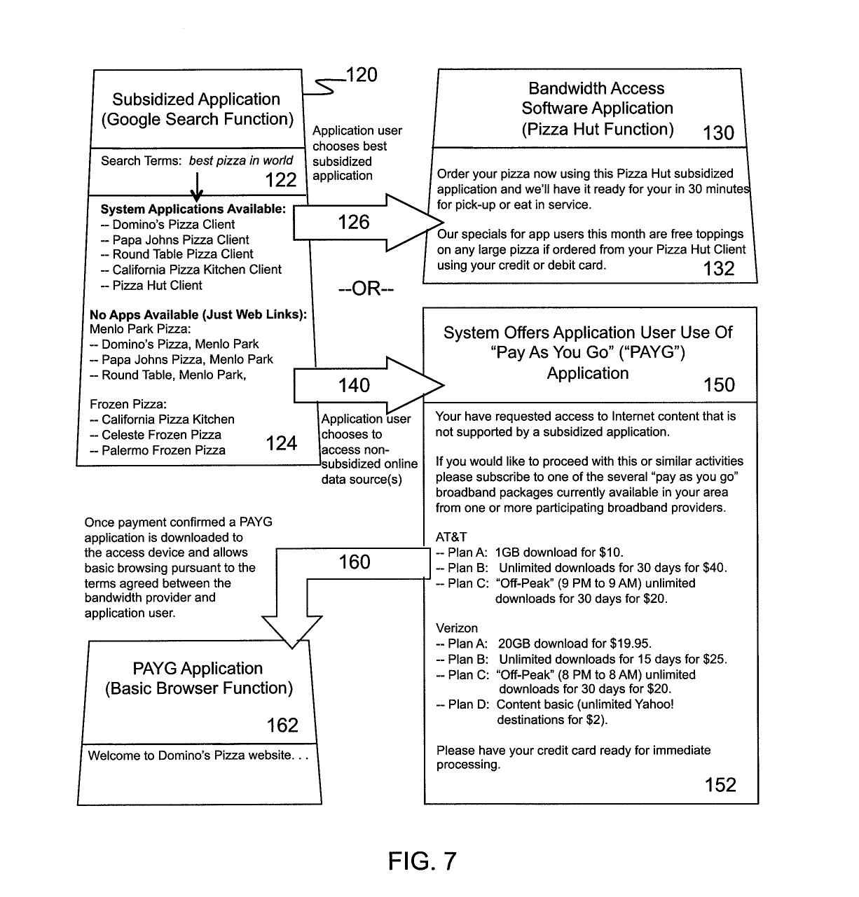

In a seventh mode a “pay as you go” subsidized application (“PAYG subsidized application” 162 as shown in FIG. 7 herein) that provides free or discounted bandwidth access to one or more pre-determined target devices 92 (e.g., destinations are restricted) or to any target content source of the PAYG application user's choosing (e.g., destinations are unrestricted) may be offered by a PAYG application provider and/or PAYG access provider. This specialized PAYG subsidized application 162 allows the PAYG application user to purchase bandwidth (perhaps at full price or at a discount) directly from a PAYG access provider and/or PAYG application provider for use accessing restricted Internet target devices 92 (e.g., destinations pre-selected by the access provider 3 and/or application provider 2) or unrestricted Internet target devices 92 chosen by the PAYG application user, and have the bandwidth consumption monitored, recorded, audited, and reported back to the PAYG access provider and registry 61 from within the PAYG subsidized application 162 itself, thereby obviating the need for inside the carrier network monitoring, recording, analyzing, and reporting of bandwidth consumption of the PAYG application user to the PAYG access provider. In this seventh mode, the registry 61 may be performing the same functions as noted above for the first mode.

In the “pay as you go” (PAYG″) scenario, the system purpose may be the same as for the first mode noted above, except that the PAYG application user utilizing the PAYG subsidized application 162 may also purchase additional bandwidth from the PAYG access provider directly to access Internet content, sites, data, or analogous information that is not accessible by a subsidized application 51 and the PAYG application user therefore needs to pay for such access “out of his own pocket”. To do so the PAYG application user will utilize a specialized PAYG subsidized application 162 which may allow the PAYG application user utilizing a separate subsidized application 51 to purchase such PAYG access from an PAYG access provider (or their agent or affiliate) paid from their bank account 85, credit card account 86, or from other sources of credit or value exchange consideration. This PAYG subsidized application 162 may monitor, record, audit, and report to the PAYG access provider and the registry 61 the amount of restricted or unrestricted PAYG access used, provide warnings periodically when such PAYG access are “near expiry” or “running low” and can terminate access when the purchased service expires or runs out. The PAYG subsidized application 162 activities reporting may be the same as for the first mode, except that the calculation and reporting of use status and payments for additional “pay as you go” restricted or unrestricted bandwidth access may be listed in a separate “pay as you go” use metering application, e.g., a “bandwidth scorecard application” akin to the use metering application 56 described above which may allow the PAYG application user of the PAYG subsidized application 162 to see how much “pay as you go” access remains before the PAYG application user must pay again for unrestricted or restricted access. With regard to the use of the PAYG subsidized application 162, the system-wide results may be the same except that calculation and reporting of use status and payments for additional PAYG subsidized application 162 restricted or unrestricted bandwidth access may be borne by the PAYG application user or a party willing to reimburse the PAYG application user directly for the use of the PAYG subsidized application 162 service and access. As to related operating environments, the above noted purpose, reporting, and result scenarios also apply in situations where the PAYG subsidized application 162 resides on a modem system, a set-top box, TV set, tablet, game console, personal computer, mobile phone, TV, embedded system (automotive, refrigerator, etc.), or any analogous device.

With regard to the seventh mode referenced above, the flow chart of FIG. 7 illustrates one methods by which the PAYG application user of a PAYG subsidized application might be prompted to subscribe to, download, and pay for a PAYG subsidized application 162 providing access to restricted or unrestricted target device 92 destinations. The FIG. 7 interaction example differentiating between a standard subsidized application 51 and a PAYG subsidized application 162 illustrates what can happen when some data that is accessible via a subsidized application 51 leads to some further data that is not supported by a subsidized application 51, e.g., steps of purchasing restricted or unrestricted access to the new data and then, e.g., launching a “browser type” PAYG subsidized application 162 that may self-meter, record, and report back on the status of bandwidth and content access being consumed by the PAYG subsidized application 162.

As an example, in a Google search subsidized application 120, search terms 122 may be entered, e.g., “best pizza in the world.” In response to this search, the search results 124 may be returned as shown in FIG. 7, showing which subsidized applications 51 that relate to the search are available for use by the application user 1:
“System Applications Available:
   Domino's Pizza subsidized application
   Papa Johns Pizza subsidized application
   Round Table Pizza subsidized application
   California Pizza Kitchen subsidized application
   Pizza Hut subsidized application
No Apps Available (Just Web Links):
   Menlo Park Pizza:
      Domino's Pizza, Menlo Park
      Papa Johns Pizza, Menlo Park
      Round Table, Menlo Park
   Frozen Pizza:
      California Pizza Kitchen
      Celeste Frozen Pizza
      Palermo Frozen Pizza”

The application user 1 may be prompted to “click-on” a result on the list shown above, such as “Pizza Hut” which when clicked upon 126 by the application user 1 would launch a pre-existing Pizza Hut subsidized application 130 relating to purchasing pizza from Pizza Hut. Thereafter the application user 1 will see, e.g., instructions 132 on how to order a pizza, and, e.g., other data or information, such as a discount offers. On the other hand, the application user 1 may wish to click on another search response, such as a pizza restaurant not supported by a pre-existing subsidized application 51 as identified, in which event the click through 140 would result in the application user 1 being taken to a “pay as you go” service prompt page 150 where the application user 1 is prompted as to the steps to take to get to the Internet resources that are supported by a PAYG subsidized application 162. Once payment is confirmed 160, a PAYG subsidized application 162 (perhaps in the form of a standard web browser) is delivered to the access device 7 and launched thereupon, and will allow access to content (unrestricted and/or restricted based upon the terms of the “pay as you go” agreement between the application user 1 (however, in this instance the application user 1 become a PAYG application user) and the PAYG application provider (e.g., a PAYG access provider, content provider, interested third party payor, or affiliates/other parties 4).

As will be understood by those skilled in the art, specific agreements to purchase “pay as you go” access can take numerous forms. In FIG. 7 an example of such an agreement process is given where the instructions for purchasing “pay as you go” access may be in the following form on a payg access package agreement page 152 as presented to the PAYG application provider from a “pay as you go” service prompt page 150 launched on the access device 7:
“You have requested access to Internet content that is not supported by a subsidized application.
If you would like to proceed with this or similar activities please subscribe to one of the several “pay as you go” broadband packages currently available in your area from one or more participating broadband service providers.
AT&T®
   Plan A: 1 GB download for $10.
   Plan B: Unlimited downloads for 30 days for $40.
   Plan C: “Off-Peak” (9 PM to 9 AM) unlimited downloads for 30 days for $20.
Verizon
   Plan A: 1 GB download for $19.95.
   Plan B: Unlimited downloads for 15 days for $25.
   Plan C: “Off-peak” (8 PM to 8 AM) unlimited downloads for 30 days for $20.
   Plan D: Content basic (Unlimited Yahoo! destinations for $2).
Please have your credit card ready for immediate processing.”

After the PAYG application user selects one of the “pay as you go” broadband packages and completes the “pay as you go” payment process (credit card details of the PAYG application user provided, etc.) the PAYG application user can then be provided with a PAYG subsidized application 162 as downloaded to the access device 7 which will launch and take the PAYG application user to the selected page, such as the “Domino's Pizza Website” accessed via the PAYG subsidized application 162, e.g., with such access bandwidth being paid for by the PAYG application user according to terms agreed with the PAYG access provider (or other party such as an PAYG application provider) when the PAYG subsidized application 162 service plan was purchased by the PAYG application user.

Moreover, and as will be understood by those skilled in the art, there are other functional features that can be integrated to the example modes set forth above. For instance, a subsidized application 51 could be configured by the application provider 2 to allow the application user 1 who utilizes the subsidized application 51 to receive the consideration 5 (cash or in-kind, whether based on a bandwidth reimbursement rate only or as an affiliate commission on advertisements or retail sales) that would have been paid to the access provider 3 by the application provider 2 as contemplated in the modes above. In this case, the application user 1 would simply pay directly the access provider 3 for bandwidth consumed and billed by the access provider 3.

Another aspect on the current system 10 would allow for subsidized applications 51 to work on devices that they were not intended to reside on (e.g., an application created for the California market with a Californian access provider 3 participant being utilized on a host device in New York), save that in these circumstances the use of the subsidized application 51 would not give rise to a settlement system instruction 73 from the settlement engine 12 and/or registry 61, but whose bandwidth consumption would instead be treated by the relevant carrier servicing the host device as normal bandwidth consumption to be billed to the application user 1 account as if it were not a subsidized application 51, but a normal Internet enabled application that consumed bandwidth attributable to the application user's 1 account.

These and other more complicated subsidized application 51 system designs (to be created by specialized application development kits 41) are possible and can incorporate elements from the following system subsidy and payment mechanisms:
a. subsidized applications 51 designed for the partial payment of bandwidth costs where the application user 1 utilizing the subsidized application 51 must pay part of the bandwidth cost directly to the access provider 3 as part of a “application provider partial pay” model.;
b. subsidized applications 51 designed for the full or partial payment of bandwidth costs directly to the application user 1 utilizing the subsidized application 51 as opposed to the access provider 3 (i.e. the application provider 2 must pay part or all of the bandwidth cost directly to the application user 1 utilizing the subsidized application 51 as part of this “application provider pays application user” model. In this case, the application user 1 utilizing the subsidized application 51 would still need to pay the access provider 3 directly for bandwidth used.
c. subsidized applications 51 designed for the logging of advertising elements within the subsidized application 51 that the application provider 2 receives payment for and which they can also share revenues with the access provider 3 and/or the application user 1 utilizing the subsidized application 51 (“advertising affiliate” model).
d. subsidized applications 51 designed for the logging of commerce actions (sales of goods and services) within the subsidized application 51 that the application provider 2 receives payment for and which they can also share sales commissions with the access provider 3 and/or the application user 1 utilizing the subsidized application 51 (“affiliate marketer” model).
e. Logging all activities of the application user 1 utilizing the subsidized application 51 (bandwidth used, time spent on subsidized application, advertisements viewed, items purchased) and the application provider 2 rewarding the application user 1 utilizing the subsidized application 51 with cash, unrestricted bandwidth credits (for use apart from a subsidized application 51), credits for other applications, subsidized applications 51, and content (music, film, games), and/or offline goods and services.
f. Coordinating the online and bandwidth management activities of the subsidized application 51 with those online and bandwidth activities of other non-subsidized applications resident on the access device 7 so that the application provider 2 can enable free or subsidized bandwidth usage by one or more such other applications on the access device 7 that is independent of the subsidized application 4 so provided. In this regard, the other applications (e-mail, photo sharing, etc.) that normally consume bandwidth without a subsidy can “tether” or “piggy back” their bandwidth activities through a particular subsidized application 51, and allow an interested third party payor 2 to grant subsidized capabilities to that particular other application on the access device 7.

Turning to FIG. 8, there is illustrated schematically in block diagram form tools and operating platforms required to create the application activity system 10. As previously discussed, the first component of the system 10 is comprised of a content and services brokerage engine 31 that facilitates the negotiation and construction of bandwidth subsidy agreements amongst system 10 participants (and/or further agreements with regard to other subsidized value inputs of the parties) and can be maintained by the system 10 administrator in the “cloud” (meaning for purposes of this application, that part of the network, i.e., the Internet, outside of the hardware and software constituting the carrier's network (e.g., the network of the access provider 3). Moreover, the content and services brokerage engine 31 may provide a set of standard input templates by which any software programmer (e.g., the application provider 2 or its agents) can construct a viable and agreeable subsidy framework, e.g., including price, quantities, parties, and other terms relating to the value inputs (commercial terms 32), the type of application to be created by the interested third party payor 2 or their agent (via application input templates 33), and the settlement methods 34 to be employed by the parties (cash, in-kind, etc.), and submit the agreed upon framework as brokerage data output 35 to relevant commercial participants (e.g., access provider 3, application provider 2, affiliates/other parties 4, etc.) and also to the registry 61 as discussed herein.

In terms of how the content and services brokerage engine 31 might be experienced by a new prospective application provider 2 engaging with it for the first time on the web, those versed in the art can appreciate that there will be a variety of forms that such a content and services brokerage engine 31 could take, and in particular how a content and services brokerage engine web site store front (a web site point of access) might function and be utilized by an application provider 2, such a party subsidizing as an example an application user 1 using bandwidth access. By way of example, this type of content and services brokerage engine web site store front may enable the subsidizing party (the soon to be application provider 2) to be prompted by the web site through numerous web pages in the process of negotiating a bandwidth subsidy deal with an access provider 3. In a simple embodiment, these pages might comprise nine activity page levels that are related to the application provider 2 (i) getting started, (ii) creating an account, (iii) logging in, (iv) selecting a subsidized application 51 type, (v) selecting a region(s) where the subsidized application 51 will be honored by the access provider 3 (e.g., what georgraphic regions), (vi) the list of carrier(s) that will honor the subsidized application 51, (vii) the bandwidth plan(s) to be applicable to the subsidized application 51 (e.g., prices for, speeds of, and quanties of bandwidth to be associated with the subsidized application 51), (viii) the agreement of terms by the parties relating to the creation of such subsidized application 51, and (ix) an content and services brokerage engine ADK download page 100 where an uniquely customized application development kit 41 may be downloaded from.

In this regard, in FIG. 8 the web-based ADK download page 100 at the “level (ix)” activity selection referecned above will prompt the subsidizing party (application provider 2) with instructions as follows:
“Download application development (“ADK”).
Now that you have agreed to pay the access provider for the bandwidth consumed by your soon to be created subsidized application(s) when used by one of your viewers or customers, please download your ADK to create the subsidized application(s) which you may then distribute to your viewers or customers through the various carrier operated subsidized application marketplaces (see upload instructions below left).
Note—each subsidized application thereafter created with this ADK is to be associated with an application provider ID code “1234-abcd” and billable to you for bandwidth consumed by the resulting subsidized application pursuant to the terms agreed herein.”

In this FIG. 8 example, the application provider 2 is given the opportunity to click on a button on this web-based ADK download page 100 to download the application development kit 41, or in the aternative click on a button to upload an existing subsidized application 51 or another button which may be used by parties seeking subsidization to search for and download subsidized applications 51 for use according to aspects of the disclosed subject matter.

Should the terms as selected by the soon to be application provider 2 be agreed to by the application provider by clicking on the button to download the application development kit 41, then the content and services brokerage engine 31 will deliver the application development kit 41 to the subsidizing application provider 2, e.g., downloaded via path 101 to an application provider ADK download environment 40 of the application provider's 2 choosing for the utilization of the application development kit 41 and subsequent creation of a subsidized application 51, e.g., for providing bandwidth network access to a party, such as an application user 1 on an access device 7.

Simultaneously, the content and services brokerage engine 31 will forward 102 a copy of the brokerage data output 35 to the registry 61 for further processing and management as previously described above.

Turning back to the application development kit 41 in FIG. 8, once the application provider 2 has the application development kit 41 downloaded to the application provider ADK download environment 40, the application provider 2, using the application development kit 41 can then assemble 103 a subsidized application 51, utilizing the application development kit 41. The subsidized application 51 can then be uploaded 104 by the application provider 2 into one or more online subsidized application marketplaces 46. The subsidized application marketplace 46 can be maintained by the access provider 2, the subsidizing application provider 2, or by a third party. Subsidized applications 51 may thereafter be searched for by parties seeking subsidization of bandwidth access, such as, application user 1 and downloaded 105 from the subsidized application marketplace 46 onto the application user's 1 access device 7. Such application user 1 access device 7 may comprise, as and example, a mobile phone, a PDA, a tablet, a game console, a computer, a set-top box, etc.

The application user 1 utilizing the subsidized application 51 may then request access to a target device 92 (to access target content) through 106 an access device Internet service provider (“ISP”) 90, which may then be routed through one or more carrier networks (cloud 99) to a target device 92, with such last data request transport step 107 into the target device 92 being through a target device Internet service provider (“ISP”) 91. The target content obtained from the target device 92 can then be served 108 through the target device ISP 91 and the cloud 99 and back through 109 the access device ISP 90 to the application user 1 utilizing the subsidized application 51 on the access device 7.

Thereafter the target content data is received into the subsidized application 51 and utilized by the application user 1 (processed, stored, manipulated, forwarded to others, etc.). In this regard the subsidized application 51 will self-monitor all relevant online access activites relating to the performance of the subsidized application 51 and record, process, and report 110 this activity (and other requisite data as described above) to the registry 61 in the form of application data output 55.

Once the application data output 55 is processed by the registry in conjunction with the brokerage data output 35, the resulting registry data output 63 can be forwarded to requisite parties (including the settlement engine 71 via path 111) for further processing and action. In the case of the requisite settlement engine 71 steps to be taken, the registry data output 63 can be further processed by the settlement engine 71 and the results (e.g., settlement system instructions 73, settlement engine data output 74, etc.) forwarded 112 to one or more interested parties (e.g., the access provider settlement systems 81, application provider settlement systems 82, other vendor/affiliate settlement systems 83, and application user settlement systems 84, application providers 2, access providers 3, affiliates/other parties 4, third party beneficiaries, etc.).

In light of the aforementioned, the system 10 as described herein does not require that the subsidized application 51 be specifically authenticated (e.g., through an access level gateway or analogous) by the network that it is accessing target content through. This is because the subsidized application 51 in the preferred embodiment is accessing a target device over pre-existing, authenticated Internet connection(s) already provided by the access provider 3 to the access device 7. As such, the network of the carrier does not “see” a toll-free application when the subsidized application 51 makes a data request of the network. Instead the network simply sees a standard application and the carrier network records (utilizing existing in-network metering protocols) the bandwidth usage of the access device 7 according to the terms of service agreed by the access provider 3 and the owner of the access device 7 when the device was authorized to access the network (e.g., when the modem was authenticated by the network). The present invention builds upon this existing network structure paradigm and simply has the “self monitoring” application tally its own bandwidth usage (and other results of using the subsidized application 51) and reports this subsidized usage record to the carrier after the fact (via the registry 61 and/or settlement engine 71). In doing so, the carrier can easily “net out” the subsidized bandwidth use from the bandwidth bill associated with access device 7 as the carrier knows that it will be paid for such netted out bandwidth amounts by the application provider 2 (or their agents and affiliates).

By way of example, in the case of a low income access device 7 owner, an application user 1 may subscribe to the lowest cost bandwidth plan of a carrier (perhaps 100% “pay as you go” plan with no flat rate monthly charges) and thereafter only utilize fully-subsidized applications on the access device 7. In this case, the owner of the access device 7 (the application user 1) would never incur a monthly bill for using the device online since all bandwidth charges initially recorded by the carrier network as part of the original “pay as you go” access agreement would be netted out in full by the subsidized bandwidth amounts tallied by the subsidized applications 51 used and thereafter aggregated in the registry 61 and/or settlement engine 71 before being forward back to the access provider 3—who in turn would credit the account of the access device 7 owner for such amounts (rendering a zero balance at each periodic netting event).

Further advantages of the system include that he subsidized application 51 can reside on a device (e.g., mobile phone, tablet, game console, computer, set-top box, embedded system, modem, etc.) that already has authorization to access the network of the access provider 3. In this regard (and as mentioned above) the subsidized application 51 can operate just like any other Internet enabled application (consuming bandwidth as it goes). Therefore, there is relatively little cost for the access provider 3 to adopt the system 10. No other current Internet data reverse billing (“toll-free”) system does this. In addition, functions that limit the access of data (speed of data, quantum of data, time of data delivery, source destinations of content, conditions precedent for data delivery, etc.) to the application user 1 are not managed by servers or intelligence within the access provider's 3 network (e.g., through an access level gateway or network firewall), but instead are controlled by the coded instructions inside the subsidized application 51 itself (e.g., “inside-the-application firewall or inside-the-application limiting protocols, etc.) and additional permissioning elements and/or modules are not needed in the access provider's network.

A further benefit of the system 10 herein is that the subsidizing application provider 2 is not necessarily the provider of target content. Subsidized applications 51 can be created by any interested third party payor (content provider, government, carriers, merchants, advertisers, individual, etc.) that wishes to subsidize the cost of bandwidth to the application user 1 utilizing the subsidized application 51 in return for, e.g., some benefit received from the application user 1. No other Internet data reverse billing system does this. In the prior art for “reverse billing” or “toll-free” models for bandwidth, it is the “sender pays” model (the creator of the subsidized application 51 specifically enabling the reverse billing only does so for the delivery of its own content). In the current invention, the subsidizing application provider 2 may or may not be affiliated with the target device 92, and as such the system 10 is not accurately described as a “sender pays” model, but an “interested third party pays” model.

Furthermore, the subsidized application 51 can work with all access provider 3 networks. Subsidized applications 51 can also reside on a device even where the access provider 3 has not embraced the use of the subsidized application 51 through the application activity system 10. In such an instance, the subsidized application 51 performs just like any other subsidized application 51 resident on the device and consumes bandwidth in a similar manner (the device application user 1 pays directly to the access provider 3 for the bandwidth consumed by the subsidized application 51—just as he or she does for any other Internet enabled application). The subsidized application 51 works even where the access provider 3 does not participate with the subsidized application 51 activity system 10. Subsidized applications 51 can be created by the subsidizing application provider 2 even when the access provider 3 has not provided prices to the content and services brokerage engine 31 in FIG. 6. In such a case, the subsidizing application provider 2 can be given the opportunity of “pre-loading” paid-for bandwidth into the subsidized application 51 (via the application development kit 41) at a bandwidth cost reimbursement rate selected by the subsidizing application provider 2 and disclosed to the application user 1 in the subsidized application 51. The application user 1 then can simply input its own bandwidth provider (ISP, cellular network, etc.) account details (“data connection service account ID code”) and payment instructions into the subsidized application 51 prior to using it, and the subsidized application, activity system registry 61, and the settlement engine 71 can ensure that the offered subsidy from the subsidizing application provider 2 is paid to the access provider 3 for the account of the application user 1. As an example, the subsidized application 51 can allow the application user 1 on the access device 7 to download up to a certain amount of bandwidth access, such as 10 MB per day, of which the application user 1 can be so informed, and have the bandwidth provider account (the account being referenced by the data connection service account ID code) of the application user 1 be thereafter directly reimbursed by the by the application provider 2 for $0.01 per MB per day, up to $1.00 total over some specified period of time, e.g., the next year, which the subsidized application 51 allows the application user 1 to accept as a term.

In addition to the aforementioned subsidized application 51 use cases and system architectures, each subsidized application 51 can be hosted on different types of devices with different levels and means of bandwidth connectivity. For instance, in one embodiment the subsidized applications 51 (e.g., the application provider 2 pays model, etc.) are designed and deployed for use in one locality (e.g., Menlo Park, Calif.) and on one type of hosted on one device. However, these same subsidized applications 51 could nonetheless be utilized by different carriers for completing the bandwidth connectivity in this same region on the same device. By way of example, a modem device (home gateway) could host one set of subsidized applications 51 that conveys data through an xDSL line enabled by an xDSL modem chipset resident within the gateway. Simultaneously, a second set of subsidized applications 51 could also be resident on this same gateway but be configured to convey data using a separate line (e.g., a 3G baseband chipset operating on a cellular line). The novel and favorable result would be that an application provider 2 could seek at least two bids from two access providers 3 prior to agreeing to such payment terms for the delivery of data through their affiliated subsidized application 51. The application user 1 could literally switch their residential access provider 3 every day (without penalty) if they wanted, as opposed to every twelve months as is often the case today.

In another variant, the two access providers could actually share the same bandwidth line enabled within the home gateway (e.g., two 3G carriers who support a shared 3G baseband chipset). For instance, two cellular carriers could offer competing PAYG subsidized application 162 services to the PAYG application user of the home gateway when they sought access to data outside of the subsidized application 51 ecosystem (wishing to engage with an Internet resource that was not supported by a subsidized application 51).

In addition, it is contemplated that one embodiment may not use the content and services brokerage engine 31 to agree on bandwidth pricing and terms with an access provider 3 at all, but will instead allow the application provider 2 to set the value of the bandwidth themselves (the tariff to include how much the application provider 2 is willing to pay directly to the application user 1 utilizing the subsidized application 51 for use of the same, during specific times, for specific actions) and offer to pay the application user 1 utilizing the subsidized application 51 for the bandwidth consumed by their subsidized application 51. In such an embodiment, the access provider 3 does not play a role in the subsidy of the bandwidth, but merely provides the bandwidth access on its normal terms at arm's length with the application user 1 (e.g., $40 charged to the application user 1 for the consumption of retail bandwidth using the subsidized application). As for the payments to be made to the application user 1 utilizing the subsidized application 51, they could be paid directly by the application provider 2 to the application user's 1 own settlement system—such as their bank account, bandwidth account (with AT&T®, Comcast®, etc.), or a third party credit aggregator (PayPay®, Visa® Card, etc.). Where the application provider 2 did not wish to make these payments to the application user's 1 own settlement systems, they could also have the operator of the registry 61 make payments on their behalf to the application user 1 utilizing the subsidized application 51 (thereby limiting the complexity of payment processing for the application provider 2).

In addition, it is contemplated that one embodiment of the disclosed subject matter may not use the content and services brokerage engine 31 at all, but will instead use a web-based variant content and services brokerage engine input system (“variant content and services brokerage engine”) that allows the application provider 2 to negotiate with a third party beneficiary (a charity, public agency, or other entity) for the payment by the application provider 2 of a pre-determined amount (cash or in-kind good or service) to such third party beneficiary in exchange for the application user 1 using a specialized third party beneficiary application in a particular fashion (during certain hours of the day, for certain time periods, sequentially over a period of days, downloading or sending a particular amount of data, viewing an extra ad, etc.). Currently some web sites (using standard browsers) will donate a percentage of their on-site sales revenue to one or more charities of choice (which is also an option for the subsidized applications 51 envisioned herein), however the current art does not extend to a self-monitoring third party beneficiary application that can measure far more than a sale of a good or service, but instead measure an application user's 1 behavior apart from purchasing goods or services. Also, because the third party beneficiary application is isolated from other web surfing activities, people are more likely to feel comfortable with the web engagement monitoring. In effect, there still exists a modified three way trade taking place between the parties (the application user 1, application provider 2, and the third party beneficiary—as discussed herein), but now the access provider 3 (the party providing the bandwidth) is not needed per se since the bandwidth is already paid for by the application user 1 (the last leg of the three-way trade involves the third party beneficiary receiving some form of payment from the application provider 2 and the application user 1 receiving “satisfaction” that the third party beneficiary has benefitted by the actions of the application user 1.

As with the previous embodiments of the system 10 described herein, the administrator of the system 10 assists in structuring the payment parameters between the application provider 2 and the third party beneficiary, which would include the creation of a customized variant application development kit for creating such third party beneficiary applications and then a back-end registry 61 that would receive meta data from the third party beneficiary application after it has been used by the application user 1. This meta data collected than would form the basis for providing settlement and payment instructions between the parties as per their original intent memorialized in the variant content and services brokerage engine.

By way of example, an application user 1 (application user 1 utilizing the third party beneficiary application) would access content at www.amazon.com using the third party beneficiary application created by Amazon® (application provider 2) over a bandwidth network to which the application user 1 already subscribes and pays a carrier for such subscription. The Amazon® third party beneficiary application would record all access activity and this data would be used to instruct Amazon® to pay the third party beneficiary (as pre-determinable by Amazon®) a cash sum for each quantum of activity (time, data consumed, etc.) engaged in by the third party beneficiary application between application user 1 and Amazon® (data sent, time spent, etc.). In terms of the value inputs (the three-way trade)
application user 1 avails itself of Amazon® content in exchange for knowing that their access activities will prompt Amazon® to make a charitable contribution to the third party beneficiary.
Amazon® promotes its commercial services to application user 1 by promising to make a charitable contribution to the third party beneficiary.
Third party beneficiary (e.g., a charity focused on promoting online connectivity) receives funds or other resources to effect their charitable mission.

Given the commercial and operational flexibility that a subsidized application 51 provides to value chain participants (application users 1, access providers 3, application providers 2, affiliates/other parties 4, third party beneficiaries, and others) it will be understood by those skilled in the art that such a technology solution enables numerous cross-subsidy relationships across the online value chain and its participants.

In this regard, Table 1 maps additional basic use cases available according to aspects of the disclosed subject matter within the application activity system 10. The variety demonstrates the value in having subsidized applications 51 outside of a carrier network at the “edge” because such a granular, iterative approach can be utilized to construct very many commercial revenue sharing and subsidy relationships between, e.g., access providers 3, application providers 2, third party beneficiaries, application users 1, and other parties whether they be content providers, merchants, government agencies, and other entities wishing to engage with the application user 1. Looked at another way, these bandwidth enabled activities might not be technically or economically feasible if these same commercial relationships had to be “coded into” the carrier network directly (access monitoring, recording, and reporting intelligence installed and maintained directly on carrier network infrastructure). The costs of doing such network coding, and inherent risk to the network core efficacy (moving data from one part of the network to another as efficiently as possible) by adding this complexity on top of a network not designed to handle this level of, e.g., required metering, auditing, and billing associated with bandwidth, online commerce, and content, could simply be too great.

As such, a platform for deploying many subsidized applications 51 from varying sources of application provider 2 candidates, with the online activity intelligence being hosted outside of the carrier's network (at the edge), can be envisioned, whether as subsidized applications 51 managing simple bandwidth subsidy activities, basic browsing functions, revenue sharing functions, or otherwise as is made technically practical and valuable.

To this end, in a first set of subsidized applications in Table 1 some form of subsidized element is provided to the application user 1 by a subsidy provider, i.e., the individual accessing and utilizing the subsidized application 51 utilizing bandwidth network access, which may be provided by an application provider 2 coming within one of several noted categories of subsidy provider, e.g., (i) a content provider, (ii) a social network provider, (iii) content aggregator/portal, (iv) online service provider (e-mail, video, etc.), (v) online merchant, (vi) access provider 3 (wireless/wireline), (vii) government service provider, each of which may act as a subsidizer, e.g., of the application user's 1 access to bandwidth network usage.

Similarly, the subsidy user (the party benfitting from the use of the subsidy) can be one or more of the application user 1, access provider 3, or a party that is neither an the application user 1 nor an access provider 3 (“NAU/NAP”).

As can also be seen from Table 1, the subsidized element can be: (i) free bandwidth, (ii) discounted bandwidth, (iii) free online content (images, film, TV, audio, text), (iv) discounted online content (images, film, TV, audio, text), (v) free goods and services (excluding online content) procured and/or delivered in-whole online or in-part online (clothing, food, travel, medical care, utilities, financial services, education, books, DVDs, CDs, etc.), (vi) discounted goods and services (excluding online content) procured and/or delivered in-whole online or in-part online (clothing, food, travel, medical care, utilities, financial services, education, books, DVDs, CDs, etc.), (vii) free goods and services procured and/or delivered in-whole offline or in-part offline (clothing, food, travel, medical care, utilities, financial services, education, books, DVDs, CDs, etc.), (viii) discounted goods and services procured and/or delivered in-whole offline or in-part offline (clothing, food, travel, medical care, utilities, financial services, education, books, DVDs, CDs, etc.).

As can also be seen in Table 1, the core subsidy parameter may relate to data that is sent to or received by a subsidy provider (e.g., such as a content provider enabling access to and from their web site), or data sent to or received by a party other than the subsidy provider (e.g., such as a content provider enabling access to and from another content provider's web site).

In the case of instances where the subsidy is being provided to the application user 1 a first subset may apply wherein there is: (i) minimal time spent using the subsidized applications 51 and/or (ii) minimal bandwidth consumed by the subsidized application 51 and/or (iii) minimal engagement activities (e.g., advertisements viewed, clicked, items purchased, etc.) conducted by the application user 1 in using the subsidized applications 51 and/or (iv) minimal non-subsidized application 51 engagement activities (e.g., device rental fees, basic bandwidth subscription package, affiliated offline commercial activities, etc.) and/or (v) exclusive engagement activities (e.g., advertisements viewed, clicked, items purchased, etc.) conducted using a system subsidized application 51 and/or exclusive non-subsidized application 51 engagement activities (e.g., device rental fees, basic bandwidth subscription package, affiliated offline commercial activities, etc.).

A second subset may also apply whereby the application user 1 has spent time using a subsidized application 51 that may: (i) be limited to certain time periods and/or (ii) time spent using a subsidized application 51 limited to certain time quantum and/or (iii) bandwidth consumed by the use of the subsidized application 51 being subject to download speed maximums and/or (iv) bandwidth consumed by using a subsidized application 51 subject to a limitation(s) relating to a data cap per specified time period, etc.

Moreover, in these various permutations a subsidy mechanism may comprise: (i) cash or substitute consideration paid by a subsidy provider to a party controlling delivery of the element and/or (ii) cash or substitute consideration paid by the subsidy provider directly to the subsidy recipient upon the subsidy recipient demonstrating (a) a cash payment and/or (b) substitute consideration has been delivered to the party controlling the delivery of element for such subsidized element having been provided to the subsidy recipient.

The ellipses (“ . . . ”) appearing in the Table 1 show that the entries are repeated.

TABLE 1

| Subsidy | Subsidized | Subsidy | |
|---|---|---|---|
| Provider | Element | Recipient | Core Subsidy Parameter |
| Content Provider | Free OR | Application | Applicable To Data Sent To Or |
| | Discounted | User | Received By Content Provider |
| | Online Access | | |
| Social Network | Free OR | Application | Applicable To Data Sent To Or |
| Provider | Discounted | User | Received By Social Network Provider |
| | Online Access | | |
| Content | Free OR | Application | Applicable To Data Sent To Or |
| Aggregator/ | Discounted | User | Received By Content Aggregator/ |
| Portal | Online Access | | Portal |
| Online Service | Free OR | Application | Applicable To Data Sent To Or |
| Provider (E-Mail, | Discounted | User | Received By Online Service Provider |
| Video, Etc.) | Online Access | | |
| Online Merchant | Free OR | Application | Applicable To Data Sent To Or |
| | Discounted | User | Received By Online Merchant |
| | Online Access | | |
| Access Provider | Free OR | Application | Applicable To Data Sent To Or |
| (Wireless/ | Discounted | User | Received By Access Provider |
| Wireline) | Online Access | | |
| Govt Service | Free OR | Application | Applicable To Data Sent To Or |
| Provider | Discounted | User | Received By Govt Service Provider |
| | Online Access | | |
| Content Provider | Free OR | Application | Applicable To Data Sent To Or |
| | Discounted | User | Received By A Party Other Than The |
| | Online Access | | Content Provider |
| Social Network | Free OR | Application | Applicable To Data Sent To Or |
| Provider | Discounted | User | Received By A Party Other Than The |
| | Online Access | | Social Network Provider |
| Content | Free OR | Application | Applicable To Data Sent To Or |
| Aggregator/ | Discounted | User | Received By A Party Other Than The |
| Portal | Online Access | | Content Aggregator/Portal |
| Online Service | Free OR | Application | Applicable To Data Sent To Or |
| Provider (E-Mail, | Discounted | User | Received By A Party Other Than The |
| Video, etc.) | Online Access | | Online Service Provider |
| Online Merchant | Free OR | Application | Applicable To Data Sent To Or |
| | Discounted | User | Received By A Party Other Than The |
| | Online Access | | Online Merchant |
| Access Provider | Free OR | Application | Applicable To Data Sent To Or |
| (Wireless/ | Discounted | User | Received By A Party Other Than The |
| Wireline) | Online Access | | Access Provider |
| Govt Service | Free OR | Application | Applicable To Data Sent To Or |
| Provider | Discounted | User | Received By A Party Other Than The |
| | Online Access | | Govt Service Provider |
| Content Provider | Free OR | Application | Applicable To Data Sent To Or |
| | Discounted | User | Received By Content Provider |
| | Online Content | | |
| Social Network | Free OR | Application | Applicable To Data Sent To Or |
| Provider | Discounted | User | Received By Social Network Provider |
| | Online Content | | |
| Content | Free OR | Application | Applicable To Data Sent To Or |
| Aggregator/ | Discounted | User | Received By Content Aggregator/ |
| Portal | Online Content | | Portal |
| Online Service | Free OR | Application | Applicable To Data Sent To Or |
| Provider (E-Mail, | Discounted | User | Received By Online Service Provider |
| Video, Etc.) | Online Content | | |
| Online Merchant | Free OR | Application | Applicable To Data Sent To Or |
| | Discounted | User | Received By Online Merchant |
| | Online Content | | |
| Access Provider | Free OR | Application | Applicable To Data Sent To Or |
| (Wireless/ | Discounted | User | Received By Access Provider |
| Wireline) | Online Content | | |
| Govt Service | Free OR | Application | Applicable To Data Sent To Or |
| Provider | Discounted | User | Received By Govt Service Provider |
| | Online Content | | |
| Content Provider | Free OR | Application | Applicable To Data Sent To Or |
| | Discounted | User | Received By A Party Other Than The |
| | Online Content | | Content Provider |
| Social Network | Free OR | Application | Applicable To Data Sent To Or |
| Provider | Discounted | User | Received By A Party Other Than The |
| | Online Content | | Social Network Provider |
| Content | Free OR | Application | Applicable To Data Sent To Or |
| Aggregator/ | Discounted | User | Received By A Party Other Than The |
| Portal | Online Content | | Content Aggregator/Portal |
| Online Service | Free OR | Application | Applicable To Data Sent To Or |
| Provider (E-Mail, | Discounted | User | Received By A Party Other Than The |
| Video, Etc.) | Online Content | | Online Service Provider |
| Online Merchant | Free OR | Application | Applicable To Data Sent To Or |
| | Discounted | User | Received By A Party Other Than The |
| | Online Content | | Online Merchant |
| Access Provider | Free OR | Application | Applicable To Data Sent To Or |
| (Wireless/ | Discounted | User | Received By A Party Other Than The |
| Wireline) | Online Content | | Access Provider |
| Govt Service | Free OR | Application | Applicable To Data Sent To Or |
| Provider | Discounted | User | Received By A Party Other Than The |
| | Online Content | | Govt Service Provider |
| Content Provider | Free OR | Application | Applicable To Data Sent To Or |
| | Discounted | User | Received By Content Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Social Network | Free OR | Application | Applicable To Data Sent To Or |
| Provider | Discounted | User | Received By Social Network Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content | Free OR | Application | Applicable To Data Sent To Or |
| Aggregator/ | Discounted | User | Received By Content Aggregator/ |
| Portal | Goods And | | Portal |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Service | Free OR | Application | Applicable To Data Sent To Or |
| Provider (E-Mail, | Discounted | User | Received By Online Service Provider |
| Video, Etc.) | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Merchant | Free OR | Application | Applicable To Data Sent To Or |
| | Discounted | User | Received By Online Merchant |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Access Provider | Free OR | Application | Applicable To Data Sent To Or |
| (Wireless/ | Discounted | User | Received By Access Provider |
| Wireline) | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Govt Service | Free OR | Application | Applicable To Data Sent To Or |
| Provider | Discounted | User | Received By Govt Service Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content Provider | Free OR | Application | Applicable To Data Sent To Or |
| | Discounted | User | Received By A Party Other Than The |
| | Goods And | | Content Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Social Network | Free OR | Application | Applicable To Data Sent To Or |
| Provider | Discounted | User | Received By A Party Other Than The |
| | Goods And | | Social Network Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content | Free OR | Application | Applicable To Data Sent To Or |
| Aggregator/ | Discounted | User | Received By A Party Other Than The |
| Portal | Goods And | | Content Aggregator/Portal |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Service | Free OR | Application | Applicable To Data Sent To Or |
| Provider (E-Mail, | Discounted | User | Received By A Party Other Than The |
| Video, Etc.) | Goods And | | Online Service Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Merchant | Free OR | Application | Applicable To Data Sent To Or |
| | Discounted | User | Received By A Party Other Than The |
| | Goods And | | Online Merchant |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Access Provider | Free OR | Application | Applicable To Data Sent To Or |
| (Wireless/ | Discounted | User | Received By A Party Other Than The |
| Wireline) | Goods And | | Access Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Govt Service | Free OR | Application | Applicable To Data Sent To Or |
| Provider | Discounted | User | Received By A Party Other Than The |
| | Goods And | | Govt Service Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content Provider | Free OR | Application | Applicable To Data Sent To Or |
| | Discounted | User | Received By Content Provider |
| | Goods And | | |
| | Services | | |
| | Procured | | |
| | And/Or | | |
| | Delivered In- | | |
| | Whole Offline | | |
| | Or In-Part | | |
| | Offline | | |
| Social Network | Free OR | Application | Applicable To Data Sent To Or |
| Provider | Discounted | User | Received By Social Network Provider |
| | Goods And | | |
| | Services | | |
| | Procured | | |
| | And/Or | | |
| | Delivered In- | | |
| | Whole Offline | | |
| | Or In-Part | | |
| | Offline | | |
| Content | Free OR | Application | Applicable To Data Sent To Or |
| Aggregator/ | Discounted | User | Received By Content Aggregator/ |
| Portal | Goods And | | Portal |
| | Services | | |
| | Procured | | |
| | And/Or | | |
| | Delivered In- | | |
| | Whole Offline | | |
| | Or In-Part | | |
| | Offline | | |
| Online Service | Free OR | Application | Applicable To Data Sent To Or |
| Provider (E-Mail, | Discounted | User | Received By Online Service Provider |
| Video, Etc.) | Goods And | | |
| | Services | | |
| | Procured | | |
| | And/Or | | |
| | Delivered In- | | |
| | Whole Offline | | |
| | Or In-Part | | |
| | Offline | | |
| Online Merchant | Free OR | Application | Applicable To Data Sent To Or |
| | Discounted | User | Received By Online Merchant |
| | Goods And | | |
| | Services | | |
| | Procured | | |
| | And/Or | | |
| | Delivered In- | | |
| | Whole Offline | | |
| | Or In-Part | | |
| | Offline | | |
| Access Provider | Free OR | Application | Applicable To Data Sent To Or |
| (Wireless/ | Discounted | User | Received By Access Provider |
| Wireline) | Goods And | | |
| | Services | | |
| | Procured | | |
| | And/Or | | |
| | Delivered In- | | |
| | Whole Offline | | |
| | Or In-Part | | |
| | Offline | | |
| Govt Service | Free OR | Application | Applicable To Data Sent To Or |
| Provider | Discounted | User | Received By Govt Service Provider |
| | Goods And | | |
| | Services | | |
| | Procured | | |
| | And/Or | | |
| | Delivered In- | | |
| | Whole Offline | | |
| | Or In-Part | | |
| | Offline | | |
| Content Provider | Free OR | Application | Applicable To Data Sent To Or |
| | Discounted | User | Received By A Party Other Than The |
| | Goods And | | Content Provider |
| | Services | | |
| | Procured | | |
| | And/Or | | |
| | Delivered In- | | |
| | Whole Offline | | |
| | Or In-Part | | |
| | Offline | | |
| Social Network | Free OR | Application | Applicable To Data Sent To Or |
| Provider | Discounted | User | Received By A Party Other Than The |
| | Goods And | | Social Network Provider |
| | Services | | |
| | Procured | | |
| | And/Or | | |
| | Delivered In- | | |
| | Whole Offline | | |
| | Or In-Part | | |
| | Offline | | |
| Content | Free OR | Application | Applicable To Data Sent To Or |
| Aggregator/ | Discounted | User | Received By A Party Other Than The |
| Portal | Goods And | | Content Aggregator/Portal |
| | Services | | |
| | Procured | | |
| | And/Or | | |
| | Delivered In- | | |
| | Whole Offline | | |
| | Or In-Part | | |
| | Offline | | |
| Online Service | Free OR | Application | Applicable To Data Sent To Or |
| Provider (E-Mail, | Discounted | User | Received By A Party Other Than The |
| Video, Etc.) | Goods And | | Online Service Provider |
| | Services | | |
| | Procured | | |
| | And/Or | | |
| | Delivered In- | | |
| | Whole Offline | | |
| | Or In-Part | | |
| | Offline | | |
| Online Merchant | Free OR | Application | Applicable To Data Sent To Or |
| | Discounted | User | Received By A Party Other Than The |
| | Goods And | | Online Merchant |
| | Services | | |
| | Procured | | |
| | And/Or | | |
| | Delivered In- | | |
| | Whole Offline | | |
| | Or In-Part | | |
| | Offline | | |
| Access Provider | Free OR | Application | Applicable To Data Sent To Or |
| (Wireless/ | Discounted | User | Received By A Party Other Than The |
| Wireline) | Goods And | | Access Provider |
| | Services | | |
| | Procured | | |
| | And/Or | | |
| | Delivered In- | | |
| | Whole Offline | | |
| | Or In-Part | | |
| | Offline | | |
| Govt Service | Free OR | Application | Applicable To Data Sent To Or |
| Provider | Discounted | User | Received By A Party Other Than The |
| | Goods And | | Govt Service Provider |
| | Services | | |
| | Procured | | |
| | And/Or | | |
| | Delivered In- | | |
| | Whole Offline | | |
| | Or In-Part | | |
| | Offline | | |
| Content Provider | Free OR | Access | Applicable To Data Sent To Or |
| | Discounted | Provider | Received By Content Provider |
| | Online Access | | |
| Social Network | Free OR | Access | Applicable To Data Sent To Or |
| Provider | Discounted | Provider | Received By Social Network Provider |
| | Online Access | | |
| Content | Free OR | Access | Applicable To Data Sent To Or |
| Aggregator/ | Discounted | Provider | Received By Content Aggregator/ |
| Portal | Online Access | | Portal |
| Online Service | Free OR | Access | Applicable To Data Sent To Or |
| Provider (E-Mail, | Discounted | Provider | Received By Online Service Provider |
| Video, Etc.) | Online Access | | |
| Online Merchant | Free OR | Access | Applicable To Data Sent To Or |
| | Discounted | Provider | Received By Online Merchant |
| | Online Access | | |
| Access Provider | Free OR | Access | Applicable To Data Sent To Or |
| (Wireless/ | Discounted | Provider | Received By Access Provider |
| Wireline) | Online Access | | |
| Govt Service | Free OR | Access | Applicable To Data Sent To Or |
| Provider | Discounted | Provider | Received By Govt Service Provider |
| | Online Access | | |
| Content Provider | Free OR | Access | Applicable To Data Sent To Or |
| | Discounted | Provider | Received By A Party Other Than The |
| | Online Access | | Content Provider |
| Social Network | Free OR | Access | Applicable To Data Sent To Or |
| Provider | Discounted | Provider | Received By A Party Other Than The |
| | Online Access | | Social Network Provider |
| Content | Free OR | Access | Applicable To Data Sent To Or |
| Aggregator/ | Discounted | Provider | Received By A Party Other Than The |
| Portal | Online Access | | Content Aggregator/Portal |
| Online Service | Free OR | Access | Applicable To Data Sent To Or |
| Provider (E-Mail, | Discounted | Provider | Received By A Party Other Than The |
| Video, Etc.) | Online Access | | Online Service Provider |
| Online Merchant | Free OR | Access | Applicable To Data Sent To Or |
| | Discounted | Provider | Received By A Party Other Than The |
| | Online Access | | Online Merchant |
| Access Provider | Free OR | Access | Applicable To Data Sent To Or |
| (Wireless/ | Discounted | Provider | Received By A Party Other Than The |
| Wireline) | Online Access | | Access Provider |
| Govt Service | Free OR | Access | Applicable To Data Sent To Or |
| Provider | Discounted | Provider | Received By A Party Other Than The |
| | Online Access | | Govt Service Provider |
| Content Provider | Free OR | Access | Applicable To Data Sent To Or |
| | Discounted | Provider | Received By Content Provider |
| | Online Content | | |
| Social Network | Free OR | Access | Applicable To Data Sent To Or |
| Provider | Discounted | Provider | Received By Social Network Provider |
| | Online Content | | |
| Content | Free OR | Access | Applicable To Data Sent To Or |
| Aggregator/ | Discounted | Provider | Received By Content Aggregator/ |
| Portal | Online Content | | Portal |
| Online Service | Free OR | Access | Applicable To Data Sent To Or |
| Provider (E-Mail, | Discounted | Provider | Received By Online Service Provider |
| Video, Etc.) | Online Content | | |
| Online Merchant | Free OR | Access | Applicable To Data Sent To Or |
| | Discounted | Provider | Received By Online Merchant |
| | Online Content | | |
| Access Provider | Free OR | Access | Applicable To Data Sent To Or |
| (Wireless/ | Discounted | Provider | Received By Access Provider |
| Wireline) | Online Content | | |
| Govt Service | Free OR | Access | Applicable To Data Sent To Or |
| Provider | Discounted | Provider | Received By Govt Service Provider |
| | Online Content | | |
| Content Provider | Free OR | Access | Applicable To Data Sent To Or |
| | Discounted | Provider | Received By A Party Other Than The |
| | Online Content | | Content Provider |
| Social Network | Free OR | Access | Applicable To Data Sent To Or |
| Provider | Discounted | Provider | Received By A Party Other Than The |
| | Online Content | | Social Network Provider |
| Content | Free OR | Access | Applicable To Data Sent To Or |
| Aggregator/ | Discounted | Provider | Received By A Party Other Than The |
| Portal | Online Content | | Content Aggregator/Portal |
| Online Service | Free OR | Access | Applicable To Data Sent To Or |
| Provider (E-Mail, | Discounted | Provider | Received By A Party Other Than The |
| Video, Etc.) | Online Content | | Online Service Provider |
| Online Merchant | Free OR | Access | Applicable To Data Sent To Or |
| | Discounted | Provider | Received By A Party Other Than The |
| | Online Content | | Online Merchant |
| Access Provider | Free OR | Access | Applicable To Data Sent To Or |
| (Wireless/ | Discounted | Provider | Received By A Party Other Than The |
| Wireline) | Online Content | | Access Provider |
| Govt Service | Free OR | Access | Applicable To Data Sent To Or |
| Provider | Discounted | Provider | Received By A Party Other Than The |
| | Online Content | | Govt Service Provider |
| Content Provider | Free OR | Access | Applicable To Data Sent To Or |
| | Discounted | Provider | Received By Content Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Social Network | Free OR | Access | Applicable To Data Sent To Or |
| Provider | Discounted | Provider | Received By Social Network Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content | Free OR | Access | Applicable To Data Sent To Or |
| Aggregator/ | Discounted | Provider | Received By Content Aggregator/ |
| Portal | Goods And | | Portal |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Service | Free OR | Access | Applicable To Data Sent To Or |
| Provider (E-Mail, | Discounted | Provider | Received By Online Service Provider |
| Video, Etc.) | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Merchant | Free OR | Access | Applicable To Data Sent To Or |
| | Discounted | Provider | Received By Online Merchant |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Access Provider | Free OR | Access | Applicable To Data Sent To Or |
| (Wireless/ | Discounted | Provider | Received By Access Provider |
| Wireline) | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Govt Service | Free OR | Access | Applicable To Data Sent To Or |
| Provider | Discounted | Provider | Received By Govt Service Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content Provider | Free OR | Access | Applicable To Data Sent To Or |
| | Discounted | Provider | Received By A Party Other Than The |
| | Goods And | | Content Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Social Network | Free OR | Access | Applicable To Data Sent To Or |
| Provider | Discounted | Provider | Received By A Party Other Than The |
| | Goods And | | Social Network Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content | Free OR | Access | Applicable To Data Sent To Or |
| Aggregator/ | Discounted | Provider | Received By A Party Other Than The |
| Portal | Goods And | | Content Aggregator/Portal |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Service | Free OR | Access | Applicable To Data Sent To Or |
| Provider (E-Mail, | Discounted | Provider | Received By A Party Other Than The |
| Video, Etc.) | Goods And | | Online Service Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Merchant | Free OR | Access | Applicable To Data Sent To Or |
| | Discounted | Provider | Received By A Party Other Than The |
| | Goods And | | Online Merchant |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Access Provider | Free OR | Access | Applicable To Data Sent To Or |
| (Wireless/ | Discounted | Provider | Received By A Party Other Than The |
| Wireline) | Goods And | | Access Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Govt Service | Free OR | Access | Applicable To Data Sent To Or |
| Provider | Discounted | Provider | Received By A Party Other Than The |
| | Goods And | | Govt Service Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content Provider | Free OR | Access | Applicable To Data Sent To Or |
| | Discounted | Provider | Received By Content Provider |
| | Goods And | | |
| | Services | | |
| | Procured | | |
| | And/Or | | |
| | Delivered In- | | |
| | Whole Offline | | |
| | Or In-Part | | |
| | Offline | | |
| Social Network | Free OR | Access | Applicable To Data Sent To Or |
| Provider | Discounted | Provider | Received By Social Network Provider |
| | Goods And | | |
| | Services | | |
| | Procured | | |
| | And/Or | | |
| | Delivered In- | | |
| | Whole Offline | | |
| | Or In-Part | | |
| | Offline | | |
| Content | Free OR | Access | Applicable To Data Sent To Or |
| Aggregator/ | Discounted | Provider | Received By Content Aggregator/ |
| Portal | Goods And | | Portal |
| | Services | | |
| | Procured | | |
| | And/Or | | |
| | Delivered In- | | |
| | Whole Offline | | |
| | Or In-Part | | |
| | Offline | | |
| Online Service | Free OR | Access | Applicable To Data Sent To Or |
| Provider (E-Mail, | Discounted | Provider | Received By Online Service Provider |
| Video, Etc.) | Goods And | | |
| | Services | | |
| | Procured | | |
| | And/Or | | |
| | Delivered In- | | |
| | Whole Offline | | |
| | Or In-Part | | |
| | Offline | | |
| Online Merchant | Free OR | Access | Applicable To Data Sent To Or |
| | Discounted | Provider | Received By Online Merchant |
| | Goods And | | |
| | Services | | |
| | Procured | | |
| | And/Or | | |
| | Delivered In- | | |
| | Whole Offline | | |
| | Or In-Part | | |
| | Offline | | |
| Access Provider | Free OR | Access | Applicable To Data Sent To Or |
| (Wireless/ | Discounted | Provider | Received By Access Provider |
| Wireline) | Goods And | | |
| | Services | | |
| | Procured | | |
| | And/Or | | |
| | Delivered In- | | |
| | Whole Offline | | |
| | Or In-Part | | |
| | Offline | | |
| Govt Service | Free OR | Access | Applicable To Data Sent To Or |
| Provider | Discounted | Provider | Received By Govt Service Provider |
| | Goods And | | |
| | Services | | |
| | Procured | | |
| | And/Or | | |
| | Delivered In- | | |
| | Whole Offline | | |
| | Or In-Part | | |
| | Offline | | |
| Content Provider | Free OR | Access | Applicable To Data Sent To Or |
| | Discounted | Provider | Received By A Party Other Than The |
| | Goods And | | Content Provider |
| | Services | | |
| | Procured | | |
| | And/Or | | |
| | Delivered In- | | |
| | Whole Offline | | |
| | Or In-Part | | |
| | Offline | | |
| Social Network | Free OR | Access | Applicable To Data Sent To Or |
| Provider | Discounted | Provider | Received By A Party Other Than The |
| | Goods And | | Social Network Provider |
| | Services | | |
| | Procured | | |
| | And/Or | | |
| | Delivered In- | | |
| | Whole Offline | | |
| | Or In-Part | | |
| | Offline | | |
| Content | Free OR | Access | Applicable To Data Sent To Or |
| Aggregator/ | Discounted | Provider | Received By A Party Other Than The |
| Portal | Goods And | | Content Aggregator/Portal |
| | Services | | |
| | Procured | | |
| | And/Or | | |
| | Delivered In- | | |
| | Whole Offline | | |
| | Or In-Part | | |
| | Offline | | |
| Online Service | Free OR | Access | Applicable To Data Sent To Or |
| Provider (E-Mail, | Discounted | Provider | Received By A Party Other Than The |
| Video, Etc.) | Goods And | | Online Service Provider |
| | Services | | |
| | Procured | | |
| | And/Or | | |
| | Delivered In- | | |
| | Whole Offline | | |
| | Or In-Part | | |
| | Offline | | |
| Online Merchant | Free OR | Access | Applicable To Data Sent To Or |
| | Discounted | Provider | Received By A Party Other Than The |
| | Goods And | | Online Merchant |
| | Services | | |
| | Procured | | |
| | And/Or | | |
| | Delivered In- | | |
| | Whole Offline | | |
| | Or In-Part | | |
| | Offline | | |
| Access Provider | Free OR | Access | Applicable To Data Sent To Or |
| (Wireless/ | Discounted | Provider | Received By A Party Other Than The |
| Wireline) | Goods And | | Access Provider |
| | Services | | |
| | Procured | | |
| | And/Or | | |
| | Delivered In- | | |
| | Whole Offline | | |
| | Or In-Part | | |
| | Offline | | |
| Govt Service | Free OR | Access | Applicable To Data Sent To Or |
| Provider | Discounted | Provider | Received By A Party Other Than The |
| | Goods And | | Govt Service Provider |
| | Services | | |
| | Procured | | |
| | And/Or | | |
| | Delivered In- | | |
| | Whole Offline | | |
| | Or In-Part | | |
| | Offline | | |
| Content Provider | Free OR | NAU/NAP | Applicable To Data Sent To Or |
| | Discounted | | Received By Content Provider |
| | Online Access | | |
| Social Network | Free OR | NAU/NAP | Applicable To Data Sent To Or |
| Provider | Discounted | | Received By Social Network Provider |
| | Online Access | | |
| Content | Free OR | NAU/NAP | Applicable To Data Sent To Or |
| Aggregator/ | Discounted | | Received By Content Aggregator/ |
| Portal | Online Access | | Portal |
| Online Service | Free OR | NAU/NAP | Applicable To Data Sent To Or |
| Provider (E-Mail, | Discounted | | Received By Online Service Provider |
| Video, Etc.) | Online Access | | |
| Online Merchant | Free OR | NAU/NAP | Applicable To Data Sent To Or |
| | Discounted | | Received By Online Merchant |
| | Online Access | | |
| Access Provider | Free OR | NAU/NAP | Applicable To Data Sent To Or |
| (Wireless/ | Discounted | | Received By Access Provider |
| Wireline) | Online Access | | |
| Govt Service | Free OR | NAU/NAP | Applicable To Data Sent To Or |
| Provider | Discounted | | Received By Govt Service Provider |
| | Online Access | | |
| Content Provider | Free OR | NAU/NAP | Applicable To Data Sent To Or |
| | Discounted | | Received By A Party Other Than The |
| | Online Access | | Content Provider |
| Social Network | Free OR | NAU/NAP | Applicable To Data Sent To Or |
| Provider | Discounted | | Received By A Party Other Than The |
| | Online Access | | Social Network Provider |
| Content | Free OR | NAU/NAP | Applicable To Data Sent To Or |
| Aggregator/ | Discounted | | Received By A Party Other Than The |
| Portal | Online Access | | Content Aggregator/Portal |
| Online Service | Free OR | NAU/NAP | Applicable To Data Sent To Or |
| Provider (E-Mail, | Discounted | | Received By A Party Other Than The |
| Video, Etc.) | Online Access | | Online Service Provider |
| Online Merchant | Free OR | NAU/NAP | Applicable To Data Sent To Or |
| | Discounted | | Received By A Party Other Than The |
| | Online Access | | Online Merchant |
| Access Provider | Free OR | NAU/NAP | Applicable To Data Sent To Or |
| (Wireless/ | Discounted | | Received By A Party Other Than The |
| Wireline) | Online Access | | Access Provider |
| Govt Service | Free OR | NAU/NAP | Applicable To Data Sent To Or |
| Provider | Discounted | | Received By A Party Other Than The |
| | Online Access | | Govt Service Provider |
| Content Provider | Free OR | NAU/NAP | Applicable To Data Sent To Or |
| | Discounted | | Received By Content Provider |
| | Online Content | | |
| Social Network | Free OR | NAU/NAP | Applicable To Data Sent To Or |
| Provider | Discounted | | Received By Social Network Provider |
| | Online Content | | |
| Content | Free OR | NAU/NAP | Applicable To Data Sent To Or |
| Aggregator/ | Discounted | | Received By Content Aggregator/ |
| Portal | Online Content | | Portal |
| Online Service | Free OR | NAU/NAP | Applicable To Data Sent To Or |
| Provider (E-Mail, | Discounted | | Received By Online Service Provider |
| Video, Etc.) | Online Content | | |
| Online Merchant | Free OR | NAU/NAP | Applicable To Data Sent To Or |
| | Discounted | | Received By Online Merchant |
| | Online Content | | |
| Access Provider | Free OR | NAU/NAP | Applicable To Data Sent To Or |
| (Wireless/ | Discounted | | Received By Access Provider |
| Wireline) | Online Content | | |
| Govt Service | Free OR | NAU/NAP | Applicable To Data Sent To Or |
| Provider | Discounted | | Received By Govt Service Provider |
| | Online Content | | |
| Content Provider | Free OR | NAU/NAP | Applicable To Data Sent To Or |
| | Discounted | | Received By A Party Other Than The |
| | Online Content | | Content Provider |
| Social Network | Free OR | NAU/NAP | Applicable To Data Sent To Or |
| Provider | Discounted | | Received By A Party Other Than The |
| | Online Content | | Social Network Provider |
| Content | Free OR | NAU/NAP | Applicable To Data Sent To Or |
| Aggregator/ | Discounted | | Received By A Party Other Than The |
| Portal | Online Content | | Content Aggregator/Portal |
| Online Service | Free OR | NAU/NAP | Applicable To Data Sent To Or |
| Provider (E-Mail, | Discounted | | Received By A Party Other Than The |
| Video, Etc.) | Online Content | | Online Service Provider |
| Online Merchant | Free OR | NAU/NAP | Applicable To Data Sent To Or |
| | Discounted | | Received By A Party Other Than The |
| | Online Content | | Online Merchant |
| Access Provider | Free OR | NAU/NAP | Applicable To Data Sent To Or |
| (Wireless/ | Discounted | | Received By A Party Other Than The |
| Wireline) | Online Content | | Access Provider |
| Govt Service | Free OR | NAU/NAP | Applicable To Data Sent To Or |
| Provider | Discounted | | Received By A Party Other Than The |
| | Online Content | | Govt Service Provider |
| Content Provider | Free OR | NAU/NAP | Applicable To Data Sent To Or |
| | Discounted | | Received By Content Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Social Network | Free OR | NAU/NAP | Applicable To Data Sent To Or |
| Provider | Discounted | | Received By Social Network Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content | Free OR | NAU/NAP | Applicable To Data Sent To Or |
| Aggregator/ | Discounted | | Received By Content Aggregator/ |
| Portal | Goods And | | Portal |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Service | Free OR | NAU/NAP | Applicable To Data Sent To Or |
| Provider (E-Mail, | Discounted | | Received By Online Service Provider |
| Video, Etc.) | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Merchant | Free OR | NAU/NAP | Applicable To Data Sent To Or |
| | Discounted | | Received By Online Merchant |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Access Provider | Free OR | NAU/NAP | Applicable To Data Sent To Or |
| (Wireless/ | Discounted | | Received By Access Provider |
| Wireline) | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Govt Service | Free OR | NAU/NAP | Applicable To Data Sent To Or |
| Provider | Discounted | | Received By Govt Service Provider |
| | Goods And | | |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content Provider | Free OR | NAU/NAP | Applicable To Data Sent To Or |
| | Discounted | | Received By A Party Other Than The |
| | Goods And | | Content Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Social Network | Free OR | NAU/NAP | Applicable To Data Sent To Or |
| Provider | Discounted | | Received By A Party Other Than The |
| | Goods And | | Social Network Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content | Free OR | NAU/NAP | Applicable To Data Sent To Or |
| Aggregator/ | Discounted | | Received By A Party Other Than The |
| Portal | Goods And | | Content Aggregator/Portal |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Service | Free OR | NAU/NAP | Applicable To Data Sent To Or |
| Provider (E-Mail, | Discounted | | Received By A Party Other Than The |
| Video, Etc.) | Goods And | | Online Service Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Online Merchant | Free OR | NAU/NAP | Applicable To Data Sent To Or |
| | Discounted | | Received By A Party Other Than The |
| | Goods And | | Online Merchant |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Access Provider | Free OR | NAU/NAP | Applicable To Data Sent To Or |
| (Wireless/ | Discounted | | Received By A Party Other Than The |
| Wireline) | Goods And | | Access Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Govt Service | Free OR | NAU/NAP | Applicable To Data Sent To Or |
| Provider | Discounted | | Received By A Party Other Than The |
| | Goods And | | Govt Service Provider |
| | Services | | |
| | (Excluding | | |
| | Online | | |
| | Content) | | |
| | Procured | | |
| | And/Or | | |
| | Delivered In- | | |
| | Whole Online | | |
| | Or In-Part | | |
| | Online | | |
| Content Provider | Free OR | NAU/NAP | Applicable To Data Sent To Or |
| | Discounted | | Received By Content Provider |
| | Goods And | | |
| | Services | | |
| | Procured | | |
| | And/Or | | |
| | Delivered In- | | |
| | Whole Offline | | |
| | Or In-Part | | |
| | Offline | | |
| Social Network | Free OR | NAU/NAP | Applicable To Data Sent To Or |
| Provider | Discounted | | Received By Social Network Provider |
| | Goods And | | |
| | Services | | |
| | Procured | | |
| | And/Or | | |
| | Delivered In- | | |
| | Whole Offline | | |
| | Or In-Part | | |
| | Offline | | |
| Content | Free OR | NAU/NAP | Applicable To Data Sent To Or |
| Aggregator/ | Discounted | | Received By Content Aggregator/ |
| Portal | Goods And | | Portal |
| | Services | | |
| | Procured | | |
| | And/Or | | |
| | Delivered In- | | |
| | Whole Offline | | |
| | Or In-Part | | |
| | Offline | | |
| Online Service | Free OR | NAU/NAP | Applicable To Data Sent To Or |
| Provider (E-Mail, | Discounted | | Received By Online Service Provider |
| Video, Etc.) | Goods And | | |
| | Services | | |
| | Procured | | |
| | And/Or | | |
| | Delivered In- | | |
| | Whole Offline | | |
| | Or In-Part | | |
| | Offline | | |
| Online Merchant | Free OR | NAU/NAP | Applicable To Data Sent To Or |
| | Discounted | | Received By Online Merchant |
| | Goods And | | |
| | Services | | |
| | Procured | | |
| | And/Or | | |
| | Delivered In- | | |
| | Whole Offline | | |
| | Or In-Part | | |
| | Offline | | |
| Access Provider | Free OR | NAU/NAP | Applicable To Data Sent To Or |
| (Wireless/ | Discounted | | Received By Access Provider |
| Wireline) | Goods And | | |
| | Services | | |
| | Procured | | |
| | And/Or | | |
| | Delivered In- | | |
| | Whole Offline | | |
| | Or In-Part | | |
| | Offline | | |
| Govt Service | Free OR | NAU/NAP | Applicable To Data Sent To Or |
| Provider | Discounted | | Received By Govt Service Provider |
| | Goods And | | |
| | Services | | |
| | Procured | | |
| | And/Or | | |
| | Delivered In- | | |
| | Whole Offline | | |
| | Or In-Part | | |
| | Offline | | |
| Content Provider | Free OR | NAU/NAP | Applicable To Data Sent To Or |
| | Discounted | | Received By A Party Other Than The |
| | Goods And | | Content Provider |
| | Services | | |
| | Procured | | |
| | And/Or | | |
| | Delivered In- | | |
| | Whole Offline | | |
| | Or In-Part | | |
| | Offline | | |
| Social Network | Free OR | NAU/NAP | Applicable To Data Sent To Or |
| Provider | Discounted | | Received By A Party Other Than The |
| | Goods And | | Social Network Provider |
| | Services | | |
| | Procured | | |
| | And/Or | | |
| | Delivered In- | | |
| | Whole Offline | | |
| | Or In-Part | | |
| | Offline | | |
| Content | Free OR | NAU/NAP | Applicable To Data Sent To Or |
| Aggregator/ | Discounted | | Received By A Party Other Than The |
| Portal | Goods And | | Content Aggregator/Portal |
| | Services | | |
| | Procured | | |
| | And/Or | | |
| | Delivered In- | | |
| | Whole Offline | | |
| | Or In-Part | | |
| | Offline | | |
| Online Service | Free OR | NAU/NAP | Applicable To Data Sent To Or |
| Provider (E-Mail, | Discounted | | Received By A Party Other Than The |
| Video, Etc.) | Goods And | | Online Service Provider |
| | Services | | |
| | Procured | | |
| | And/Or | | |
| | Delivered In- | | |
| | Whole Offline | | |
| | Or In-Part | | |
| | Offline | | |
| Online Merchant | Free OR | NAU/NAP | Applicable To Data Sent To Or |
| | Discounted | | Received By A Party Other Than The |
| | Goods And | | Online Merchant |
| | Services | | |
| | Procured | | |
| | And/Or | | |
| | Delivered In- | | |
| | Whole Offline | | |
| | Or In-Part | | |
| | Offline | | |
| Access Provider | Free OR | NAU/NAP | Applicable To Data Sent To Or |
| (Wireless/ | Discounted | | Received By A Party Other Than The |
| Wireline) | Goods And | | Access Provider |
| | Services | | |
| | Procured | | |
| | And/Or | | |
| | Delivered In- | | |
| | Whole Offline | | |
| | Or In-Part | | |
| | Offline | | |
| Govt Service | Free OR | NAU/NAP | Applicable To Data Sent To Or |
| Provider | Discounted | | Received By A Party Other Than The |
| | Goods And | | Govt Service Provider |
| | Services | | |
| | Procured | | |
| | And/Or | | |
| | Delivered In- | | |
| | Whole Offline | | |
| | Or In-Part | | |
| | Offline | | |

The application activity system and method according to aspects of embodiments of the disclosed subject matter, can include, as noted, a system and method for providing subsidized consumption of bandwidth and online bandwidth access to an application user 1, which may comprise one or more content and services brokerage engines 31, content and services brokerage engine web site store fronts, application development kits 41, subsidized applications 51, subsidized application marketplaces 46, application activity system registries 61, and application activity system settlement engines 71.

A registry 61 can include as an example a server, or the like, that is operated by one or more of the access providers, the application activity system operators, or a third-parties, which registry can serve to collect: (a) the terms of the application provider 2 agreement with the access provider 3, which may be obtained from the content and services brokerage engine 31 in the form of brokerage data output 35, (b) a subsidized application identification code, which may also be obtained from the content and services brokerage engine 31 in the form of brokerage data output 35 (as further incorporated into the application development kit 41), (c) an access device identification code, which may be obtained from the online access activity module 54 incorporated within the subsidized application 51 resident on such access device 7, and (d) bandwidth consumption data, which may be obtained from the online access activity module 54 incorporated within the subsidized application 51. The registry 61 can combine all these elements and/or modules into a statement of charges applicable to the participants in the system, such statement of charges then being forwarded to a settlement engine 71 for payment processing amongst the parties (e.g., delivery of invoices to parties for charges owed and the delivery of statements to parties for expectations to be received).

The settlement engine 71 can be, e.g., a payment processing server that takes the statement of charges prepared by the registry 61 and delivers settlement system instructions 73 or analogous to the relevant participating parties.

The subsidized application identification code can be a unique identification number assigned the application provider 2 by the content and services brokerage engine 31 that relates to the creation of a particular application development kit 41 as created through a particular bandwidth subsidy agreement facilitated through the content and services brokerage engine 31. As such, each time the application provider 2 makes an agreement with an access provider 3 for the provision of bandwidth for consumption by an application user 1 such unique code is created and embedded into the brokerage data output 35, and thereafter the application development kit 41, and the application data output 55 produced by the subsidized application 51, which is then shared with the registry 61. Furthermore, the system uses the subsidized application identification code to corroborate activities by having the brokerage data output 35 file sent directly to the registry 61 from the content and services brokerage engine 31 at the time of its creation.

Generally, the application provider 2 can be any interested third party payor that agrees with the access provider 3 to subsidize the consumption of bandwidth access by the application user 1 on the network of the access provider 3 in instances where the application user 1 accesses target content on target devices 92 over such network utilizing a subsidized application 51 which can be created in conjunction with the application provider 2, e.g., using an application development kit 41.

Generally, an application provider agreement can include the contract and operational terms made between the application provider 2 and the access provider 3 for the payment by the former to the latter to enable bandwidth consumption by the application user 1 utilizing a subsidized application 51 on an access device 7 to access target content on target devices over the network of the access provider 3, e.g., the application provider 2 or some other payor agreeing to pay the access provider 3 for the consumed bandwidth.

A application development kit 41 can include a software development tool that can be provided to each application provider 3, e.g., by a content and services brokerage engine 31 for the subsequent creation of subsidized applications 51 (utilizing, e.g., Android, webOS, IOS, Windows, etc.). Each application development kit 41 can also include a subsidized application identification code within its contents and this subsidized application identification code can further be embedded into any subsidized application 51 that is created with the application development kit 41.

The following is a disclosure by way of example of a computing device that may be used with the presently disclosed subject matter. The description of the various components of a computing device is not intended to represent any particular architecture or manner of interconnecting the components. Other systems that have fewer or more components may also be used with the disclosed subject matter. A communication device may constitute a form of a computing device and may at least include a computing device. The computing device may include a computing device level interconnect (e.g., a bus and system core logic), which can interconnect such components of a computing device to a data processing device, such as a processor(s) or microprocessor(s), or other form of partly or completely programmable or pre-programmed (e.g., hard wired and or application specific customized logic circuitry) device, such as a controller or microcontroller, a digital signal processor, or any other form of device that can fetch instructions, operate on pre-loaded/pre-programmed instructions, and/or followed hard-wired or customized circuitry to carry out logic operations that, together, perform steps of and whole processes and functionalities as described in the present disclosure.

In this description, various functions, functionalities and/or operations may be described as being performed by or caused by software program code/instructions, e.g., in order to simplify the description. However, those skilled in the art will recognize what is meant by such expressions is that the functions, functionalities, and/or operations result from execution of the software program code/instructions by a computing device as described above, e.g., including a processor, such as, a microprocessor, microcontroller, logic circuit, or the like. Alternatively, or in combination, the functions, functionalities, and/or operations can be implemented using special purpose circuitry, with or without software instructions, such as using Application-Specific Integrated Circuit (ASIC) or Field-Programmable Gate Array (FPGA), or like technologies, which may be programmable, partly programmable, or hard wired.

The application specific integrated circuit (“ASIC”) logic may be such as gate arrays or standard cells, or the like, implementing customized logic by metalization(s) interconnecting base gate arrays in the ASIC architecture or selecting and providing metalization(s) interconnect between standard cell functional blocks included in a manufacturer's library of functional blocks, etc. Embodiments can thus be implemented using hardwired circuitry without program software code/instructions, or in combination with circuitry using program software code/instructions.

Thus, the disclosed subject matter is not limited to any specific combination of hardware circuitry and software, nor to any particular source for the instructions executed by the data processor(s) within the computing device. While some embodiments can be implemented in fully functioning computers and computer systems, various embodiments are capable of being distributed as a computing device including, e.g., a variety of forms and capable of being applied regardless of the particular type of machine or tangible computer-readable media used to actually effect the performance of the functions and operations and/or the distribution of the performance of the functions, functionalities, and/or operations.

The computing device level interconnect may connect the data processing device to define logic circuitry including memory. The interconnect may be internal to the data processing device, such as coupling a microprocessor to on board cache memory or external memory such as main memory, or a disk drive. Commercially available microprocessors, one or more of which could be a computing device or part of a computing device, include a PA-RISC series microprocessor from Hewlett-Packard Company, an 24×86 or Pentium series microprocessor from Intel Corporation, a PowerPC microprocessor from IBM, a Sparc microprocessor from Sun Microsystems, Inc, or a 68xxx series microprocessor from Motorola Corporation as examples.

The computing device system level interconnect in addition to interconnecting such as microprocessor(s) and memory may also interconnect such elements to a display controller and display device, and/or to peripheral devices such as input/output (I/O) devices, e.g., through an input/output controller(s). Typical I/O devices can include a mouse, a keyboard(s), a modem(s), network interfaces, printers, scanners, video cameras, and other devices that are well known in the art. The inter-connect may include one or more buses connected to one another through various bridges, controllers and/or adapters. In one embodiment the I/O controller includes a USB (Universal Serial Bus) adapter for controlling USB peripherals, and/or an IEEE-1394 bus adapter for controlling IEEE-1394 peripherals.

The memory may include any tangible computer-readable media, which may include but are not limited to recordable and non-recordable type media such as volatile and non-volatile memory devices, such as volatile RAM (Random Access Memory), typically implemented as dynamic RAM (DRAM) which requires power continually in order to refresh or maintain the data in the memory, and non-volatile ROM (Read Only Memory), and other types of non-volatile memory, such as a hard drive, flash memory, etc. Non-volatile memory typically may include a magnetic hard drive, a magnetic optical drive, or an optical drive (e.g., a DVD RAM, a CD ROM, a DVD or a CD), or other type of memory system which maintains data even after power is removed from the system.

A server could be made up of one or more computing devices. Servers can be utilized, e.g., in a network to host a network database, compute necessary variables and information from information in the database(s), store and recover information from the database(s), track information and variables, provide interfaces for uploading and downloading information and variables, and/or sort or otherwise manipulate information and data from the database(s). In one embodiment a server can be used in conjunction with other computing devices positioned locally or remotely to perform certain calculations and functions.

At least some aspects disclosed can be embodied, at least in part, utilizing program software code/instructions. That is, the functions, functionalities and/or operations may be carried out in a computing device executing program software code/instructions, e.g., in one or more sequences of instructions fetched/retrieved from a memory, such as ROM, volatile RAM, non-volatile memory, cache, main memory, local or remote disc-drive, or other remote storage device. In general, the instructions within the program software code/instructions executed to implement the functions, functionalities and/or operations of embodiments of the disclosed subject matter may be implemented as part of an operating system or a specific application, component, program, object, module, routine or sequence of instructions usually referred to as “computer programs,” “applications” or simply “software.” The program software code/instructions typically comprise instructions stored at various times in various tangible memory and storage devices in or peripheral to a computing device, such as in cache memory, main memory, internal or external disk drives, and other remote storage devices, such as a disc farm, and when read and executed by a processor(s) in the computing device, cause the computing device to perform a method(s), e.g., process and operation steps to execute an element(s) as part of some aspect(s) of the disclosed subject matter.

Program software code/instructions executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software.” The program software code/instructions typically include one or more instructions stored at various times in various tangible memory and storage devices in or peripheral to the computing device, that, when fetched/read and executed by the computing device, as defined herein, cause the computing device to perform functions, functionalities and operations necessary to perform a method, so as to execute elements involving various aspects of the function, functionalities, and operations of the method(s) forming an aspect of the disclosed subject matter.

For the purposes of this disclosure a module is a software, hardware, or firmware (or combinations thereof) system, process or functionality, or component thereof, that performs or facilitates the processes, features, and/or functions, functionalities and/or operations described herein (with or without human interaction or augmentation) as being performed by the identified module. A module can include sub-modules. Software components of a module may be stored on a tangible machine readable medium. Modules may be integral to one or more servers, or be loaded and executed by one or more servers. One or more modules may grouped into an engine or an application.

A tangible machine readable medium can be used to store program software code/instructions and data that, when executed by a computing device, cause the computing device to perform a method(s) as may be recited in one or more accompanying claims directed to the disclosed subject matter. The tangible machine readable medium may include storage of the executable software program code/instructions and data in various tangible locations, including for example ROM, volatile RAM, non-volatile memory and/or cache and/or other tangible memory as referenced in the present application. Portions of this program software code/instructions and/or data may be stored in any one of these storage and memory devices. Further, the program software code/instructions can be obtained from other storage, including, e.g., through centralized servers or peer to peer networks and the like, including the Internet. Different portions of the software program code/instructions and data can be obtained at different times and in different communication sessions or in a same communication session.

The software program code/instructions and data can be obtained in their entirety prior to the execution of a respective software program or application by the computing device. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a tangible machine readable medium in entirety at a particular instance of time.

Examples of tangible computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, a tangible machine readable medium includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an I-phone, Blackberry Droid, or the like, or any other device including a computing device. In one embodiment, an application user 1 terminal (access device 7) can be a computing device, such as in the form of or included within a PDA, a cellular phone, a notebook computer, a tablet, a game console, a set top box, an embedded system, a TV, a personal desktop computer, etc. Alternatively, the traditional communication applications and subsidized application(S) may be used in some embodiments of the disclosed subject matter.

While some embodiments of the disclosed subject matter have been described in the context of fully functioning computing devices and computing systems, including a computing device, those skilled in the art will appreciate that various embodiments of the disclosed subject matter, including a computing device, are capable of being distributed, e.g., as a program product in a variety of forms and are capable of being applied regardless of the particular type of computing device machine or computer-readable media used to actually effect the distribution.

In various embodiments, hardwired circuitry, such as an ASIC(s), may be used in combination with software instructions to implement an aspect(s) of the disclosed subject matter. Thus, the techniques described herein are not limited to being implemented on any specific combination of hardware circuitry and software nor to any particular source for the instructions executed by any part of the computing device(s). Various functions and operations which have been described as being performed by or caused by software code to simplify description, will be understood by those skilled in the art to mean that the function(s), functionalities and/or operations resulting from execution of the code/instructions by a computing device, alone or in combination with any other computing device(s), the combination also forming a computing device.

The disclosed subject matter is described with reference to block diagrams and operational illustrations of methods and devices to provide an application activity system. It is understood that each block of a block diagram or other operational illustration (herein, collectively, “block diagram”), and combination of blocks in a block diagram, can be implemented by means of analog or digital hardware and computer program instructions. These computing device software program code/instructions can be provided to the computing device such that the instructions, which execute via the computing device, e.g., on a processor within the computing device or other data processing apparatus, such that, when so executed, the program software code/instructions cause the computing device to perform functions, functionalities and operations of a method(s) according to the disclosed subject matter, as recited in the accompanying claims, with such functions, functionalities and operations specified in the block diagram.

It will be understood that in some possible alternate implementations, the function, functionalities and operations noted in the blocks of a block diagram may occur out of the order noted in the block diagram. For example, the function noted in two blocks shown in succession can in fact be executed substantially concurrently or the functions noted in blocks can sometimes be executed in the reverse order, depending upon the function, functionalities and operations involved. Therefore, the embodiments of methods presented and described as a flowchart(s) in the form of a block diagram in the present application are provided by way of example in order to provide a more complete understanding of the disclosed subject matter. The disclosed flow and concomitantly the method(s) performed as recited in the accompanying claims are not limited to the functions, functionalities and operations illustrated in the block diagram and/or logical flow presented therein. Alternative embodiments are contemplated in which the order of the various functions, functionalities and operations may be altered and in which sub-operations described as being part of a larger operation may be performed independently or performed differently than illustrated or not performed at all.

Although some of the drawings illustrate a number of operations in a particular order, functions, functionalities and/or operations which are not now known to be order dependent or become understood to not be order dependent may be reordered and other operations may be combined or broken out. While some reordering or other groupings may have been specifically mentioned in the present application, others will be or may become apparent to those of ordinary skill in the art and so the disclosed subject matter does not present an exhaustive list of alternatives. It should also be recognized that the aspects of the disclosed subject matter may be implemented in parallel or seriatim in hardware, firmware, software or any combination(s) thereof co-located or remotely located, at least in part, from each other, e.g., in arrays or networks of computing devices, over interconnected networks, including the Internet, and the like.

The disclosed subject matter has been described with reference to one or more specific exemplary embodiments thereof. It will be evident that various modifications may be made to the disclosed subject matter without departing from the broader spirit and scope of the disclosed subject matter as set forth in the appended claims. The specification and drawings are, accordingly, to be regarded in an illustrative sense for explanation of aspects of the disclosed subject matter rather than a restrictive or limiting sense.

Thus, according to aspects of the disclosed subject matter, the system, method and network architecture disclosed can provide for an interested third party payor 2 (also sometimes a subsidizing application provider 2) to assume the cost of some or all of an application user's 1 bandwidth charges associated with accessing data through the Internet through IP-based access networks which may be operated by different access providers 3. This system for the transfer of bandwidth charges from the application user 1 to the interested third party payor 2, herein sometimes referred to as “FreeBand,” provides a system of self-aware, “charge shifting” Internet subsidized applications that can reside on a consumer device (Android, webOS, Symbian, IOS, MeeGo, Windows, etc.) and self-monitor their own bandwidth consumption for the purpose of redirecting associated Internet access charges from the application user 1 utilizing the subsidized application 51 to the subsidizing application provider 2, also referred to as the interested third party payor 2—in effect enabling the “free” or “subsidized” delivery of any data that is associated with the particular subsidized application 51.

Conceptually the application activity system is a software and hardware platform that enables each of the three main Internet connectivity value chain participants (the access provider 3 of the application user 1, the interested third party payor 2 entity subsidizing the bandwidth to the application user 1 via the subsidized application 51, and the application user 1) to more efficiently price, negotiate terms for, and exchange their value inputs to the other value chain participants. As referred to earlier in this patent application, generally each value chain participant has the following value inputs to broker (exchange for consideration): (i) access provider 3 value input: online access hardware, software, and bandwidth throughput (e.g., DSL, fiber optic, coax, 3G, LTE, WiMax, Wi-Fi, satellite) to online content and services (e.g., software applications, software subsidized applications, web pages, audio, video, social networks, communication platforms); (ii) interested third party payor 2 value input—cash resource, as well as, software applications, software subsidized applications 51, web pages, audio, video, social networks, communication platforms, advertising, and other elements that can be downloaded over bandwidth networks and/or interact with other elements over bandwidth networks; and (iii) application user 1 value input—the ability to pay for both the (a) bandwidth access and (b) the online content and services by providing consideration in the form of (y) cash or (z) in-kind services (engaging in online behavior such as participating in online advertising or online commerce).

The application activity system provides a transparent and efficient system by which each value chain participant can identify an opportunity for an economic trade in their value inputs and execute on such an opportunity through a negotiated cash and/or in-kind exchange. In its most common form, the trading of value inputs will involve at least three parties trading something of value in the form of a “multi-party trade” where consideration is delivered by a first party to a second party that in turn delivers something of value to a third party, who in turn delivers something of value to the first party (completing the circle where each party gets something new of value in exchange for their contribution). The circle can be more than three, but for purposes herein we limit examples to only three party trading groups.

By way of example, an Internet user (the application user 1) accesses content at website “X” using a custom built subsidized application 51 (e.g., any one of an Android, webOS, IOS, Windows, MeeGo, Symbian, Linux, Java subsidized application 51) created by an application provider 2 “Y” (the interested third party payor 2) over the network of the access provider 3. The subsidized application 51 accesses content from website “X” and consumes 10 MB of data sent over the network of the access provider 3. As such, the subsidized application 51 resident on the application user's 1 access device 7 (e.g., mobile phone, tablet, laptop computer, game console, set-top box, tablet, embedded system, TV, modem) records the access activity and instructs the application provider 2 (the interested third party payor 2) to pay the access provider 3 for some or all of the cost of the 10 MB of data throughput.

As the result, in its most simple form all three value chain participants benefit: (a) the application user 1 accesses online data for free or at a discount in exchange for availing itself to the subsidized application 51 provided by the interested third party payor 2; (b) the access provider 3 is paid in full or in part for online access provided to the application user 1 by a party other than the application user 1; and (c) the interested third party payor 2 (application provider 2) succeeds in driving traffic to website “X”.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

1-12. (canceled)

13. A data connection method for establishing a data connection between a subsidized application on a network connected user access device and a data source on a network connected target device over a communication network relating to the provision of data connection services to a user utilizing the subsidized application to allow the user of the subsidized application access to at least one target devices via a communication network, comprising:
a. providing, via the communication network, a content and services brokerage engine, including a content and services brokerage engine web site store front, providing, via the web site, an online sale of a data connectivity package to at least one provider of the subsidized application; and
b. accepting, via the web site the purchase by a provider of the subsidized application of the at least one data connectivity package for inclusion by the provider of the subsidized application into a subsidized application to be used by the user of the subsidized application to access at least one target device as specified by the provider of the subsidized application on a data connection basis.

14. The data connection method of claim 13, further comprising:
a. delivering, via a communication network, to each provider of the subsidized application, purchasing a data connectivity package, an application development kit for the creation of at least one subsidized application.

15. The data connection method of claim 13, wherein the application development kit delivered to the provider of the subsided application includes a subsidized application identification code associated with both the subsidized application and the provider of the subsidized application.

16. The data connection method of claim 13, further comprising:
a. forwarding, via the content and services brokerage engine, to an application activity system registry commercial terms and identification codes relating to a commitment by the provider of the subsidized application to pay data connection charges incurred by the user of the subsidized application; and
b. preparing, via the application activity system registry, data connection charges for an application activity system settlement engine to settle credits and debits among the bandwidth access provider and the provider of the subsidized application relating to the subsidized application's particular bandwidth consumption activities.

17. The data connection method of claim 13, further comprising: calculating, via the application activity system registry, data connection charges to be paid by the provider of the subsidized application resulting from the user utilizing the subsidized application to engage with at least one specific target device, and the registry forwarding data connection charges to an application activity system settlement engine for settlement between the provider of the subsidized application and the bandwidth access provider.

18. The data connection method of claim 13, wherein: consideration negotiated through the content and services brokerage engine owed by the provider of the subsidized application to the bandwidth access provider for bandwidth access provided to the user of the subsidized application comprises contingent cash consideration represented by the sharing of advertising revenues earned by the provider of the subsidized application for any on-line advertisement impressions during use by the user of the subsidized application of the network of the bandwidth access provider.

19. The data connection method of claim 13, wherein: consideration negotiated through the content and services brokerage engine owed by the provider of the subsidized application to the bandwidth access provider for bandwidth access provided to the user of the subsidized application comprises contingent cash consideration represented by the sharing of merchant revenues earned by the provider of the subsidized application from the user purchasing one of a good and a service during use by the user of the subsidized application of the network of the bandwidth access provider.

20. The data connection method of claim 13, wherein: the consideration negotiated through the content and services brokerage engine owed by the provider of the subsidized application to the bandwidth access provider for bandwidth access comprises in-kind consideration represented by the provision of one of online content and a service to the user of the subsidized application by at least one of the provider of the subsidized application and an affiliate of the provider of the subsidized application as an incentive for the user of the subsidized application to utilize the subsidized application on the network of the bandwidth access provider.

21. The data connection method of claim 13, wherein: the consideration negotiated through the content and services brokerage engine owed by the provider of the subsidized application to the bandwidth access provider for bandwidth access comprises in-kind consideration represented by the provision of one of offline content, a good, and a service to the user of the subsidized application by at least one of the provider of the subsidized application and an affiliate of the provider of the subsidized application as an incentive for the user of the subsidized application to utilize the subsidized application on the network of the bandwidth access provider.

22. The data connection method of claim 13 further comprising the step of forwarding, via the subsidized application, to an application activity system registry bandwidth consumption activities of the user utilizing the subsidized application to engage with at least one specified target device.

23-25. (canceled)
